(19) United States
(12) Patent Application Publication
(10) Pub. No.: US 2023/0374289 A1
(43) Pub. Date: Nov. 23, 2023

(54) COMPOSITION FOR USE IN THE MANUFACTURE OF AN IN-MOULD ELECTRONIC (IME) COMPONENT

(71) Applicant: ALPHA ASSEMBLY SOLUTIONS INC., Waterbury, CT (US)

(72) Inventors: Nirmalya Kumar CHAKI, Waterbury, CT (US); Chetan Pravinchandra SHAH, Waterbury, CT (US); Bawa SINGH, Waterbury, CT (US); Rahul RAUT, Waterbury, CT (US); Vasuki Srinivas KAUSHIK, Waterbury, CT (US); Ranjit PANDHER, Waterbury, CT (US); Niveditha NAGARAJAN, Waterbury, CT (US); Sandeesh M KUMAR, Waterbury, CT (US); Anubhav RUSTOGI, Waterbury, CT (US)

(21) Appl. No.: 18/247,996

(22) PCT Filed: Oct. 7, 2021
(86) PCT No.: PCT/EP2021/025396

§ 371 Date: Apr. 5, 2023

Related U.S. Application Data
(60) Provisional application No. 63/088,530, filed on Oct. 7, 2020.

(51) Int. Cl. C08L 61/28; C08K 7/18; C09D 11/103; C09D 11/104; C09J 183/04; C09D 11/033; C09J 11/08

(52) U.S. Cl. CPC C08L 61/28; C08K 7/18; C09D 11/103; C09D 11/104; C09J 183/04; C09D 11/033; C09J 11/08; C08L 2205/035; C08L 2312/00; C08L 2201/50; C08L 2201/52; C08K 2201/001; C08K 2201/005; C08K 2201/006

(57) ABSTRACT

A composition for use in the manufacture of an in-mould electronic (IME) component, the composition containing a binder comprising: a cross-linking agent comprising melamine formaldehyde, a thermoplastic resin comprising a hydroxyl group, and a solvent.

Composition for use in the manufacture of an in-mould electronic (IME) component

The invention relates to a composition for use in the manufacture of an in-mould electronic (IME) component, a method of manufacturing the composition, a method of manufacturing an in-mould electronic (IME) component, and an in-mould electronic (IME) component.

Development of human-machine interfacing electronic devices, which are highly reliable, robust, lightweight, decorative, and three-dimensionally (3D) shaped, are in high-demand for the development of next-generation automotive, white goods or consumer electronics applications.

Film Insert Molding (FIM) is a process known to integrate graphics, labeling and components to the plastic parts during a molding process. It is a form of In-Mold Decorating (IMD) or In-mold Labeling (IML). The FIM process enables one to create single and decorated plastic parts in two-dimensional (2D) to curved and complex shaped, 3D designs, which are durable and lightweight, can be used for multiple applications. In a typical FIM process, decoration (color and light transmittance) and surface functionality (scratch, anti-reflection, anti-glare, gloss, matte, anti-fingerprint, etc.) of the thermoplastic films are designed as per the application necessity and are integrated to produce robust, complex shaped and decorative plastic parts. This technology is well known for producing decorative parts for automotive, handheld electronic devices and consumer products, while several recent examples show efforts of integrating with electronic functionality. One of the ways to prepare such structures are by injection molding of screen printed and/or thermoformed conductive and dielectric inks printed electronic circuitries.

There is a desire to produce 3D injection molded, light weight plastic structures capable of performing electronics functionalities. These structures can be produced by screen printing of interconnect circuitries on flexible polymer substrates such as, for example, polycarbonate (PC) and polyethylene terephthalate (PET); attaching/assembling electronic components to these screen printed circuitries; thermoforming to produce a 3D structures of such electronics devices and followed by pouring of liquid resins to the backside of the thermoformed structures by injection molding to produce a robust and solid plastic structures. Such structures can be designed to perform capacitive and resistive touch switch applications, for wireless or blue tooth connectivity, controlling volumes or light intensity and many such applications. These injection molded electronics structures are termed as In-Mold Electronics (IME) or Injection Molded Structural Electronics (IMSE) or Plastronics or Surface Electronics.

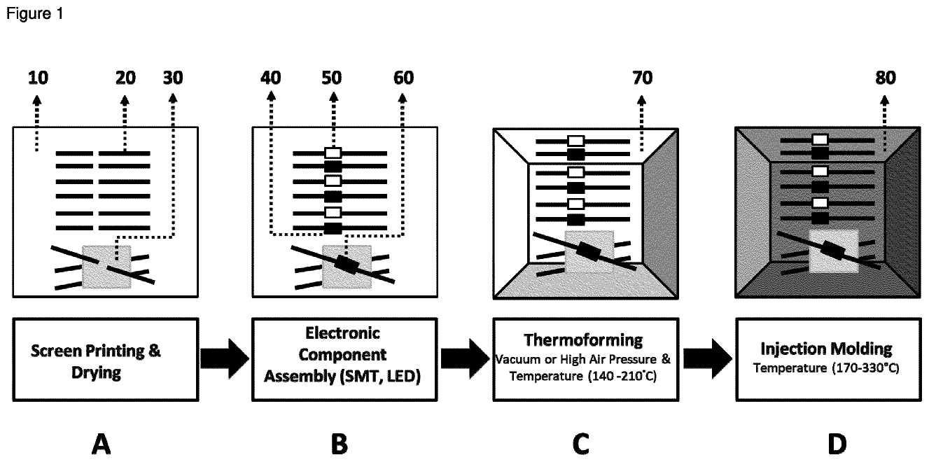

IME technology consists of the integration of several electronics and plastics manufacturing process steps: screen printing of electronic inks (conducting and dielectric inks), drying or curing of electronic inks, component attachment or electronic assembly using electronic adhesives, thermoforming and trimming to produce curved or 3D structures, and back filling of these curved or 3D structures with molten resins by injection molding. FIG. 1 depicts a schematic representation of generic manufacturing process steps of IME. In FIG. 1 four broad manufacturing processing steps are schematically represented. At A (screen printing and drying) there is shown a schematic representation of 2D, screen-printed interconnects: 10 represents thermoformable PC or PET substrates, 20 represents screen printed, electrically conducting interconnects, 30 represents screen printed, electrically insulating, dielectric layers. At B (electronic component assembly (SMT components, LEDs etc.) there is shown a schematic representation of 2D, electronic circuitries, where electronic components, LEDs, etc. are attached; 40, 50 and 60 represent different SMT components or LEDs. At C (thermoforming [vacuum or high air pressure and temperature (140-21° C.)]) there is shown a schematic representation of thermoformed, 3D, electronic circuitries (70). At D (injection molding [temperature (170-330° C.)]) there is shown a schematic representation of injection molded (filled with injection molded resin), thermoformed, 3D, electronic circuitries (80).

Electronics functionalities can be integrated with FIM structures, either in two film or single film stacks. In two films stack, electronics ink printed plastic layers are prepared separately by screen printing of conducting or dielectric inks, which further are integrated with graphic ink coated decorated plastics during injection molding steps. Both decorative and electronic functions in a single layer film structure can be fabricated in a sequential fashion, starting by first screen printing of graphic ink layers followed by screen printing of electronic inks (conducting and dielectric inks) and components attachment using conducting or non-conducting adhesives, and then the whole stack is further thermoformed and back injection molded. Plastic substrates are typically PC or PET and injection molding resins are typically selected from polycarbonate (PC), polyethylene terephthalate (PET), acrylonitrile butadiene styrene (ABS), polypropylene (PP), polyester, poly(methyl methacrylate) (PMMA), low density polyethylene (LDPE), high-density polyethylene (HDPE), polystyrene (PS), and thermoplastic polyurethane (TPU) and the like.

Typical polymer Thick Film Inks (such as, Silver, Carbon etc. and UV/thermal curable dielectric inks) and conducting adhesives are used for the construction of flexible circuits on PC and PET substrates. Though, these inks are highly flexible, these inks cannot be thermoformed as they show discontinuity and cracking while thermoforming, and thus cannot be used for IME device fabrications.

There are several challenges that need to be solved to develop fully functional and reliable IME structures, since the fabrication of IME devices requires the integration of different processing conditions, screen printing, component assembly, thermoforming, trimming and injection molding. Materials property and processing conditions and parameters of each of these steps can further affect the performance of IME devices at different stages.

For example, to achieve superior thermoforming performance of a stack; all inks (graphic ink layers and electronic ink layers) and substrates need to be highly inter-compatible and to have similar thermal stability and modulus properties. Further, such intercompatibility and thermal stability of inks and substrates contributes significantly to the success of injection molding process, which governs the overall stability and reliability of such IME structure.

Accordingly, the following issues are relevant to compositions for use in the manufacture of an IME component:

### Screen Printing and Drying:

One of the key requirements of electronic ink materials are their screen printability. For example, screen-printing of well-defined width, thickness and porosity controlled conductive traces are extremely important to construct, high performance interconnects to build circuitries, touch switches, illuminating devices and other similar devices. Similarly printing of uniform, pin-hole free, thin insulating or encapsulation films are important to construct multilayered circuitries, which often act as crossover dielectrics. Variation of deposit strcutures can signifncantly affect the eletrical fucntions of the IME and similar structures performance, thus would increase rejection rate during manufacturing. Similarly, precision dispensing, jetting, stencil printing, casting of conductive and nonconductive adhesives, encapsultants are required for assembling electronic component onto such interconnect structures.

Controlling rheology and viscosity of these formulations are one of the most important features and are responsible for depositing such defect-free conducting traces and non-conducting layers. Efficient drying and curing of these screen-printed materials would be crucial to minimize defects during thermoforming and injection molding process, thereby will increase the yield of overall IME process. Additionally, any printing and drying defects can also affect severally to the electrical and reliability performance of the 3D structural electronics or IME parts. Formulation optimizations with appropriate and compatible chemistry would be desirable to achieve fast and complete drying yet having longer screen-life while printing and providing other functional requirements, such as electrical conductivity, stretchability, and stability during injection molding. Longer screen life along with storage stability of these compositions are important for industrial applicability and manufacturability.

### Compatibility:

Intercompatibility of dielectric and conductive materials along with compatibility with different flexible polymer substrates, decorative inks, adhesives, encapsulants and injection molding resins are another one of the most important aspect for the manufacturing of IME and similar structures. Most often chemical functionalities of these materials are responsible for their compatibilities, while a perfect matching is the key for manufacturing of robust and high performing IME and similar structures, however, a non-compatible material will result a defective and non-reliable electronic device. Incompatible materials-set generate several errors, such as etching, dissolving, and delaminating of underneath layer on which another new layer is deposited.

### Electrical Properties:

Conductive electronic materials should have desirable electrical conductivities to construct electronics devices capable of switching, illuminating and touch functions. Further, higher electrical conductivities are desirable for the construction of structures those are capable of high-current carrying for performing wireless signal processing, blue-tooth connection, and ultra-high frequency sensing functions. The processing of such conductive electronic materials strictly needs to be below 150° C., as per the stability thresholds of most of the flexible substrates of choices for the manufacturing of IME and similar structures. Such conducting materials also need to maintain electrical path before and after thermoforming process without significant alteration of their electrical conductivity. It would also be important to control dielectric properties for effective insulation of high current, electrical devices. Additionally, such electrical conductors and dielectrics should have enough thermal stability to withstand injection molding processing conditions. To balance electrical properties and other functional requirements, such as thermoformability and injection molding stability, high-performance conductive and non-conductive polymer composites are needed to formulate.

### Assembly of Electronic Components:

Typical choices to assemble electronics components, such as passives, LEDs, would be to use conductive and non-conductive adhesives, which also need to withstand thermoforming and injection molding process steps. Conductive and non-conductive adhesive compositions are also disclosed, which can be either stencil printed or dispensed for assembling passives, LEDs, QFP, QFN and similar other components.

### Thermoformability:

To construct IME and similar structures, electronic materials are required to deposit on flexible polymer substrates to create 2D printed electronics structures by screen-printing and then converted into 3D form by the thermoforming process.

Thermoforming process of functional materials on various substrates opened to create new design, pattern in 3D forms which would not be possible with traditional printed circuit board technology. It is a process in which heat is utilized to soften the substrate above its glass transition/softening temperature and this temperature vary from substrate to substrate. High vacuum or pressure is also applied on soften plastics and given a specific size and shape during thermoforming process. Several other processing conditions, such as time and temperature of thermoforming process, design of tool i.e., depth or height of tool, vacuum pressure, etc. needs to optimize to get very good 3D parts. The challenges would be to design high-performing polymer composites, those could be screen printed and electrical properties of screen-printed traces (width and thickness) can be predictability control as a function of thermoforming strain and process conditions.

Additionally, aesthetic look before and after thermoforming, very good adhesion to above mentioned substrates before and after thermoforming i.e. delamination of ink should not take place on thermoforming, inter-compatibility with different inks such as dielectric for multilayer complex structure especially during thermoforming i.e. stack compatibility, flexibility and elongation so that they do not show cracks during thermoforming i.e. behavior of materials property during thermoforming, etc. Additionally, several other aesthetic defects, such as imprint of electronics circuitries (ghosting) should be avoidable, often arises due to the incompatibility of conducting and dielectric inks along with substrates or graphic ink coated substrates in combinations of in-appropriate selection of design parameters, thermoforming processing conditions and molds selections.

Stability during Injection Molding:

Screen-printed and thermoformed, flexible electronics structures are injection molded to provide structural stability, rigidity, and reliability requirements. Various resins, such as PC, ABS, ABS-PC blend, polyester, PP and TPU are used based on the performance requirements of IME and similar structures. The higher processing temperature and injection pressure are very harsh to the screen-printed circuitries, which needs to directly face the flow of the hot-injection-molding-resins. So, one of the key requirements for electronic materials, their thermal stability, as well as compatibility with incoming injection molding resin and high temperature adhesion to underneath substrates to resist any structural deformation and destructions. Often, such deformations and destructions of screen-printed features during injection molding are termed as “ink wash-off”. Ink wash-off is a serious factor that can lower the manufacturing yield of IME devices. Additionally, change of resistance before and after injection molding should also be minimum. Design of circuities along with materials composition are key to avoid ink wash-off during injection molding.

### Reliability:

A typical IME devices need to pass several environmental tests, such as 85° C./85 RH, thermal aging, thermal cycling, illumination test, etc. The reliability of IME and similar structures are finally depended on the accuracy of all the above factors as discussed and compatibility of all materials, substrates, and components. A well-depth knowledge and iterations are needed to select different compatible raw materials to formulate and optimize a highly compatible electronics material. Selection and optimization of the ratios of appropriate inorganic fillers, polymeric resins, solvents, and functional additives are important to optimize such electronic compositions for the manufacturing of IME and similar structures.

The present invention seeks to tackle at least some of the problems associated with the prior art or at least to provide a commercially acceptable alternative solution thereto.

In a first aspect, the present invention provides a composition for use in the manufacture of an in-mould electronic (IME) component, the composition containing a binder comprising:
a cross-linking agent comprising melamine formaldehyde,
a thermoplastic resin comprising a hydroxyl group, and
a solvent.

Each aspect or embodiment as defined herein may be combined with any other aspect(s) or embodiment(s) unless clearly indicated to the contrary. In particular, any features indicated as being preferred or advantageous may be combined with any other feature indicated as being preferred or advantageous.

The inventors have surprisingly found that the composition is particularly suitable for use in the manufacture of an IME component, for example as a conductive ink or a dielectric ink, and may result in the manufacture of IME components with superior robustness, environmental durability/ruggedness, mechanical flexibility, and improved operational life for electronics applications in comparison to conventional IME components.

As discussed in more detail below, the composition may comprise solid particles, such as conducting particles and non-conducting particles. The binder serves to “bind” these components of the composition together. When the composition comprises solid particles, then the binder may form the remainder of the composition together with any unavoidable impurities. When the composition does not contain solid particles, then the binder together with any unavoidable impurities may constitute the entire composition.

The term “melamine formaldehyde” as used herein may encompass a resin with melamine rings terminated with multiple hydroxyl groups derived from condensation products of two monomers, melamine, and formaldehyde. Melamine formaldehyde is sometimes referred to a “melamine formaldehyde resin”, “melamine resin” or simply “melamine”.

The term “thermoplastic resin” as used herein may encompass a plastic polymer material that becomes pliable or moldable at a certain elevated temperature and solidifies upon cooling.

The term “component” as used herein may encompass, for example, a part of an electronic component or an entire electronic component.

During a typical IME manufacturing method, a composition, such as a conductive ink or a dielectric ink, is printed on a thermoformable substrate. Prior to thermoforming, the composition is then dried, typically at an elevated temperature of up to 150° C., for example from 50 to 120° C., for a period of time to remove solvent from the composition. Without being bound by theory, it is considered that upon thermal heating of the composition of the present invention, e.g. using such typical drying temperatures and times, the melamine resin may react with the hydroxyl groups of the thermoplastic resins to form a “nitrogen-carbon-oxygen” linked, polymeric network.

Advantageously, once dried under such conditions, the binder of the present invention may exhibit two contradictory properties. At a normal operation temperature of an IME device (e.g. from about −20° C. to +50° C.) the binder may act like a thermoset showing exceptional strength, cohesion and interlayer adhesion, and a reasonable stretch-ability. However, at higher temperatures that are used during thermoforming, the binder may transform into a thermoplastic material that can be readily thermoformed into 3D structures without necking, breaking or delaminating.

Without being bound by theory, it is considered that these contradictory properties may result from the use of the cross-linking agent comprising melamine formaldehyde with the hydroxyl group-containing resins. In particular, it is considered that this advantageous balance of thermoplastic and thermoset properties is achieved by the occurrence of partial, i.e. not full, cross-linking. This is presumably because, in comparison to cross-linking agents used in conventional IME methods, melamine formaldehyde is a relatively “slow” cross-linking agent, and results in only partial cross-linking as a result of the drying temperatures and times used in a typical IME manufacturing method.

During a typical IME manufacturing process multiple thermoformable compositions are used so as to form the final component, e.g. conductive inks, dielectric inks, conductive adhesives, non-conductive adhesives, encapsulants, barrier layers etc. Advantageously, the compatibility of these materials can be improved when compositions of the present invention are used as a common platform. While each of these materials may of course include different species (e.g. conductive particles, non-conductive particles, etc.), the use of the common binder may ensure the inter-material (e.g. inter-ink) compatibility. As a result, problems with, for example, de-lamination of layers of different materials, may be reduced.

The compositions are compatible with conventional graphic ink-coated substrates, which is a desirable criteria for constructing highly functional IME structures and devices.

Flexible electronic circuits constructed using the composition may show excellent electrical performance.

The compositions may be highly compatible with injection-molding resins typically employed in an IME manufacturing method.

Use of the composition may also reduce the occurrence of ink wash-out in comparison to compositions used in conventional IME methods.

Thermoformed and injection molded structures prepared using the compositions show excellent environmental reliability features, and thus are particularly suitable for IME applications for automotive, consumer electronics and white goods applications.

Advantageously, the composition may be stable at normal storage and ambient temperatures. Again, without being bound by theory, it is considered that this is due to the substantial absence of any cross-linking by the melamine formaldehyde at such temperatures.

The melamine formaldehyde preferably comprises hexamethoxymethyl melamine. Hexamethoxymethyl melamine is a particularly suitable cross-linking agent. In addition, hexamethoxymethyl melamine is soluble in most common organic solvents except aliphatic hydrocabons.

Suitable commercial melamine formaldehyde resins include, for example, Maprenal BF 891/77SNB, Maprenal MF 600/55BIB, Maprenal MF 650/55IB, Maprenal MF 800/55IB, CYMEL 370, CYMEL 373, and CYMEL 380. Maprenal MF 600/55BIB is an imino type, highly reactive, isobutylated melamine-formaldehyde resin.

The cross-linking agent may advantageously further comprise isocyanate and/or polyisocyanate and/or blocked polyisocyanate. Such species may increase the degree of cross-linking under the drying conditions employed in conventional IME manufacturing methods. This may be advantageous when the composition is required to have increased “thermoset” properties. A “blocked”, or “masked”, isocyanate may encompass an isocyanate that contains a protected isocyanate. The isocyanate functional group is typically masked through the use of a blocking agent producing a compound that is seemingly inert at room temperature yet yields the reactive isocyanate functionality at elevated temperatures.

Suitable isocyanates, polyisocyanates and blocked polyisocyanates include, for example, toluene diisocyanate (TDI), hexamethylene diisocyanate (HDI), isophorone diisocyanate (IPDI), Desmodur BL 3175A, Desmodur BL 3272 MPA, Desmodur BL 1100/1 and Vestanat B 1358A from Evonik. These can be used alone or in a combination of melamine formaldehyde resins. VESTANAT B 1358A comprises methyl-ether-ketone-oxime (MEKO) blocked cycloaliphatic polyisocyanate based on isophorone diisocyanate (IPDI).

The thermoplastic resin preferably comprises one or more of polyurethane resin, polyester resin, polyacrylate resin, polyvinyl ester resin, phenoxy resin and ketonic resin, i.e. a hydroxyl group containing polyurethane resin, polyester resin, polyacrylate resin, polyvinyl ester resin, phenoxy resin and/or ketonic resin. Such resins are particularly suitable for use in the present invention and under the drying conditions of a typical IME manufacturing method react with melamine formaldehyde to provide the desired degree of cross-linking.

These thermoplastic resins may be used alone or in combinations with other thermoplastic resins.

The polyurethane resin may comprise, for example, a reaction product of hydroxy terminated polyol, hydroxy terminated poly(ethylene oxide), hydroxy terminated poly(dimethylsiloxane) or trimethylolpropane ethoxylate with methylbenzyl isocyanate, (trimethylsilyl) isocyanate, 1-naphthyl isocyanate, 3-(triethoxysilyl) propyl isocyanate, phenyl isocyanate, allyl isocynate, butyl isocyanate, hexyl isocyanate, cyclohexyl isocyanate, furfuryl isocyanate, isophorone diisocyanate, hexamethylene diisocyanate, m-xylylene diisocyanate, 1,4-cyclohexylene diisocyanate, poly(propylene glycol), or tolylene 2,4-di-isocyanate. The polyurethane resin may comprise one or mixture of a thermoplastic polyurethane, such as Pearlstick series of polyurethane like Pearlstick 5701, Pearlstick 5703, Pearlstick 5707, Estane series of polyurethane like ESTANE FS M92B4P, Desmocoll series of polyurethane like Desmocoll 540/4, Desmocoll 400, Desmomelt series of polyurethane like Desmomelt 540/3, Desmomelt 540/4. The phenoxy resin is preferably a thermoplastic bisphenol-A based polyether containing polyester or polyacrylate or polyurethane compounds. Examples of suitable phenoxy resins containing polyester or poly acrylate or polyurethanes include phenoxy resins available under the tradenames LEN-HB, PKHW-35, PKHH, PKHA, PKHM-301 and PKHS-40. The polyester resin, polyacrylate resin and/or polyurethane resin may contain one or more of polyols, hydroxyls, amines, carboxyl acids, amides and aliphatic chains. The phenoxy resin contain polyester or polyacrylate or polyurethane or polyether or polyamide backbone.

The thermoplastic resin preferably comprises polyurethane resin, polyester resin and phenoxy resin. More preferably, the thermoplastic resin comprises:
from 20 to 60 wt. % polyurethane resin, preferably 35 to 47 wt. % polyurethane resin,
from 5 to 30 wt. % polyester resin, preferably 13 to 19 wt. % polyester resin, and
from 20 to 60 wt. % phenoxy resin, preferably 34 to 51 wt. % phenoxy resin, based on the total weight of the thermoplastic resin.

Such thermoplastic resins, particularly in the amounts recited above, are particularly suitable for obtaining the desired degree of cross-linking with the melamine formaldehyde. The presence of polyurethane resin(s), particularly in the recited amount, may provide the dried composition with a desirable level of flexibility. The presence of polyester resin(s), particularly in the recited amount, may provide the dried composition with a desired degree of flexibility and also promote adhesion to the substrate. The presence of phenoxy resin(s), particularly in the recited amount, may promote adhesion to the substrate. The combination of these three resins, particularly in the recited amounts, may provide a favourable combination of high flexibility and high adhesion to the substrate.

Preferably, the thermoplastic resin:
comprises a homo-polymer, and co-polymer and/or a ter-polymer; and/or
has a glass transition temperature of less than 100° C.; and/or
has a weight average molecular weight of from 1000 to 100000 g/mol; and/or
has a softening point of less than 100° C.; and/or
has a hydroxyl content (OH number) of greater than 20 mgKOH/g.

In a preferred embodiment, the composition comprises:
from 1 to 40 wt % of the cross-linking agent, preferably 7 to 24 wt. % of the cross-linking agent, and
from 60 to 99 wt % of the thermoplastic resin, preferably 76 to 93 wt. % of the thermoplastic resin,

based on the total amount of cross-linking agent and thermoplastic resin. Such amounts may help to provide the desired level of cross-linking under the drying conditions of conventional IME manufacturing methods.

The solvent preferably comprises one or more of a glycol ether acetate, a glycol ether, an ester, a ketone, an alcohol and a hydrocarbon. Such solvents may be particularly suitable for use in the present invention. Such solvents may be used alone or in combination. Such solvents may be particularly suitable for dissolving the thermoplastic resins and/or cross-linking agent, and may be particularly compatible with substrates and any functional fillers and/or additives in the composition. Such solvents may have a favourable combination of polarity, solvency properties (Hansen solubility parameters), compatibility with substrates, toxicity and other physical properties, such as boiling and flash points. Such solvents may improve the composition's storage stability, drying profile, drying stability during processing (e.g. on screen during screen printing), and reactivity with substrates and other printed ink layers (such as graphic inks or electronics inks layers). Such solvents may result in a homogeneous composition that will be stable upon storing and also satisfy performance requirements. Non-limiting examples of solvents include methanol, ethanol, 2-propanol, benzyl alcohol, ethylene glycol, propylene glycol, dipropylene glycol, 1,3-butane diol, 2,5-dimethyl-2,5-hexane diol, ethylene glycol methyl ether, ethylene glycol monobutyl ether, propylene glycol phenyl ether, diethylene glycol mono-n-butyl ether, propylene glycol n-propyl ether, dipropylene glycol methyl ether, terpineol, butyl carbitol, butyl carbitol acetate, glycol ether acetates, 2-(2-ethoxyethoxy)ethyl acetate, dipropylene glycol methyl ether acetate, propylene glycol monomethyl ether acetate, 2-Butoxyethyl acetate, carbitol acetate, propylene carbonate butyl carbitol, butyl cellosolve, heptane, hexane, cyclohexane, benzene, xylene, Cyrene, dibasic ester, isophorone, C11-ketone, and toluene.

The preferably solvent comprises:
up to 95 wt % glycol ether acetate, preferably up to 85 wt. % glycol ether acetate, and/or
up to 95 wt % glycol ether, preferably up to 85 wt. % glycol ether (e.g. 1-85 wt. %), and/or
up to 15% ester, preferably up to 5 wt. % ester (e.g. 1-5 wt/%), and/or
up to 40 wt % ketone, preferably up to 32 wt. % ketone (e.g. 1-32 wt. %, and/or
up to 80 wt % alcohol, preferably up to 70 wt. % alcohol (e.g. 1-70 wt. %), and/or
up to 30 wt % hydrocarbon, preferably up to 22 wt. % hydrocarbon (e.g. 1-22 wt. %),

based on the total weight of the solvent.

Such amounts may be particularly suitable for providing the advantages described above.

The binder may preferably further comprise:
a thermosetting resin, preferably comprising one or both of acrylic resin and epoxy resin; and
a curing catalyst for curing the thermosetting resin, preferably for thermally curing the thermosetting resin and/or for UV curing the thermosetting resin.

The presence of the thermosetting resin and curing catalyst may serve to form a three-dimensional thermoset network. This may be beneficial when the dried composition is required to have more “thermoset” properties. The thermosetting resin preferably comprises one or both of acrylic resin and epoxy resin, and may be cured using a thermal curing agent and/or a UV curing agent.

The thermosetting resin may contain, for example, a polyester or a polyacrylate or a polyether or a polyurethane or a polyamide backbone. The thermosetting resin may contain different combinations of monomer, dimer, trimer, tetramer, penta or hexamer and oligomers having epoxy, polyurethane, polyester, polyether, and acrylic backbones.

Examples of the epoxy resin include bisphenol-A epoxy, 4-vinyl-1-cyclohexene 1,2-epoxide, 3,4-epxoy cyclohexyl mehyl-3′,4′-epoxy cyclohexene carboxylate, 1,4-butanediol diglycidyl ether, trimethylolpropane triglycidyl ether, triglycidyl isocyanurate, epoxy siloxane, epoxy silane and phenol novolac epoxy. The epoxy resins may comprise one or a mixture of epoxy resins, such as EPON 862, DYCK-CH, JER 828, 1,4-butanediol diglycidyl ether, 1,6-hexanediol diglycidylether (DER 731), orho-Cresyl glycidyl ether (DER 723) and C12-C14 alkyl glycidyl ether (DER 721). One or more hardeners may be present, and such hardeners may be either amine such as butyl amine, N,N-diethyl amino ethanol, or amino ethanol, acid such as oleic acid, adipic acid, or glutaric acid, or anhydrides such as succinic anhydrides, phthalic anhydrides and maleic anhydride. Epoxy acrylates may also be used. (Meth)acrylates are produced by a ring opening reaction of 1,4-butanediol diglycidyl ether, bisphenol-A epoxy, 4-vinyl-1-cyclohexene 1,2-epoxide, 3,4-epxoy cyclohexyl mehyl-3′,4′-epoxy cyclohexene carboxylate, trimethylolpropane triglycidyl ether, triglycidyl Isocyanurate, epoxy siloxane, epoxy silane, phenol novolac epoxy with methacrylic acid. The epoxy acrylate may comprise one or more of epoxy backbone based (meth)acrylates such as Ebecryl 3503, Ebecryl 3201, Photomer 3005, Photomer 3316, Ebecryl 3411, and Ebecryl 3500, by way of example and not limitation. Polyurethane acrylates such as urethane acrylate, methacrylate terminated polyurethane and modified isocynate with hydroxy ethyl methacrylate may also be used. The urethane acrylate may comprise one or more of a urethane backbone based (meth)acrylate such as SUO2371, SUO-300, SUO-7620, Photomer 6891, SUO S3000, Ebecryl 8413, Ebecryl 230, Ebecryl 4833, Ebecryl 8411, Ebecryl 270, Ebecryl 8804, and Photomer-6628, by way of example and not limitation. Polyester acrylates such as fatty acid modified pentaerythritol acrylate, trimethylolpropane triacrylate and methacrylated monosaccharides may also be used. Polyether acrylates such as poly(ethylene glycol) methyl ether acrylate, poly(ethylene glycol) methacrylate, poly(ethylene glycol) dimethacrylate may also be used. The polyester acrylate may comprise one or more of polyester backbone based (meth)acrylate such as Photomer-4006, Ebecryl 450, Photomer 5429, and Ebecryl 812, by way of example and not limitation. Non-limiting examples of monomer acrylates include, but are not limited to, methacrylic acid, 3-(trimethoxysilyl)propyl methacrylate, isoborynyl acrylate, tetrahydrofufuryl acrylate, poly(ethylene glycol) methyl ether acrylate, hydroxypropyl methacrylate, dimethylaminoethyl methacrylate, 2-ethyl hexyl acrylate, butyl acrylate, isooctyl acrylate, methyl methacrylate, lauryl acrylate, dodecyl acrylate and tetrahydrofurfuryl acrylate. Non-limiting examples of dimer acrylates include dimer methacrylates such as poly(ethylene glycol) dimethacrylate, 1,6-bis(acryloyloxy)hexane, bisphenol A-ethoxylate dimethacrylate and neopentyl glycol diacrylate 1,3-butanediol diacrylate. Non-limiting examples of trimer acrylates include trimer methacrylates such as trimethylolpropane triacrylate, pentaerythritol triacrylate and 1,3,5-triacryloylhexahydro-1,3,5-triazine. Non-limiting examples of tetramer acrylates include pentaerythritol tetracrylate and di(trimethylolpropane) tetraacrylate. Non-limiting examples of penta or hexamer acrylates include dipentaerythritol penta-acrylate and dipentaerythritol hexa-acrylate. The siloxane acrylate may comprise one or more of siloxane backbone based (meth)acrylate such as BYK-UV3570, BYK-UV3575, BYK-UV3535, BYK-UV3530, BYK-UV3505, BYK-UV3500, Ebecryl 350, Ebecryl 1360, and SUO-S3000, by way of example and not limitation. The aliphatic acrylate may comprise one or more of hydrocarbon backbone based (meth)acrylate such as Ebecryl 1300, SAP-M3905, Ebecryl 525, and SAP-7700HT40, by way of example and not limitation.

The binder preferably further comprises one of more functional additives, preferably selected from one or more of surfactants, rheology modifiers, dispersants, de-foamers, de-tackifiers, slip additives, anti-sag agents, levelling agents, surface active agents, surface tension reducing agents, adhesion promoters, anti-skinning agents, matting agents, coloring agents, dyes, pigments and wetting agents. De-foamers may remove the foam from the binder, and de-tackifiers may remove tack from the binder. The surfactants may comprise anionic, cationic or non-ionic surfactants. Non-limiting examples include surfactants available under the tradenames SPAN-80, SPAN-20, Tween-80, Triton-X-100, Sorbitan, IGEPAL-CA-630, Nonidet P-40, Cetyl alcohol, FS-3100, FS-2800, FS-2900. FS-230, FS-30, BYK-UV3500/UV3505/077/UV3530, FS-34, Modaflow 2100, Omnistab LS 292, Omnivad-1116 and Additol LED 01. Rheology Modifiers are organic or inorganic additives that control the rheological characteristics of the formulation. These can be used alone or in a mixture. Examples of suitable rheology modifiers include, but are not limited to, those available under the tradenames THIXIN-R, Crayvallac-Super, Brij 35, 58, L4, O20, S100, 93, C10, O10, L23, O10, S10 and S20. Functional additive can also be coloring agents, dyes and pigments. Non-limiting examples of coloring agents, dyes and pigments include anthraquinone dyes, azo dyes, acridine dyes, cyanine dyes, diazonium dyes, nitro dyes, nitroso dyes, quinone dyes, xanthene dyes, fluorene dyes and rhodamine dyes. Non-limiting examples of antioxidants and inhibitors include 2,6-di-tert-butyl-4-methylphenol, 2,6-di-tert-butyl-p-cresol, butylhydroxytoluene, 3,5-di-tert-4-butylhydroxytoluene, Omnistab IC, Omnistab In 515/ 516, hydroquinone and phenothiazine.

In addition to the elements recited herein, it will be understood that the composition and binder may comprise unavoidable impurities. Such unavoidable impurities, if present, are typically present in an amount of up to 1 wt. % of the composition or binder, more typically up to 0.5 wt. %, even more typically up to 0.1 wt. %, even more typically up to 0.05 wt. %.

In a preferred embodiment, the binder comprises:
from 0.5 to 12 wt. % of the cross-linking agent, preferably from 1.5 to 7.7 wt. % of the cross-linking agent;
from 10 to 40 wt. % of the thermoplastic resin, preferably from 11 to 30.4 wt. % of the thermoplastic resin; and
from 40 to 85 wt. % solvent, preferably from 46.7 to 78.8 wt. % solvent; optionally:
from 0.1 to 30 wt. % thermosetting resin and from 0.1 to 3 wt. % curing catalyst for curing the thermosetting resin, preferably from 1 to 10 wt. % thermosetting resin and from 0.1 to 1 wt. % curing catalyst for curing the thermosetting resin; and/or
from 0.1 to 20 wt % functional additives, preferably 1.7 to 17 wt. % functional additives.

Such a binder is particularly suitable for providing the composition with the advantages described above.

Preferably, the binder comprises a low level of:
ionics, more preferably substantially no ionics; and/or
free halogens, more preferably substantially no free halogens; and/or
deliberately added halogens, more preferably no deliberately added halogens.

In a preferred embodiment, the composition further comprises conductive particles, i.e. electrically conductive particles. This may enable the composition to be used as, for example, a conductive ink or a conductive adhesive.

The conductive particles preferably comprise metal particles, more preferably selected from one or more of silver particles, copper particles, brass particles, nickel particles, gold particles, platinum particles, palladium particles, metal alloy particles, silver-coated copper particles, silver-coated brass particles, silver-nickel alloy particles and silver-copper alloy particles. Such particles are particularly suitable for use in a conductive ink or conductive adhesive.

Alternatively, or in addition, the conductive particles preferably comprise non-metal particles, more preferably comprise carbon particles, preferably selected from one or more of graphite particles, graphite flakes, carbon black particles, graphene particles and carbon nanotubes. Such particles are particularly suitable for use in a conductive ink or conductive adhesive. The use of graphene may improve the mechanical, flexible and barrier properties of the composition. The combinations of graphene's unique mechanical, flexible and barrier properties may be highly beneficial for the preparation of flexible, mechanically robust, abrasion resistant and corrosion resistant carbon layers, thereby enhancing the operational life of an IME and similar structures. Additionally, incorporation of graphene to metal inks may enables the development of high-performing, low cost metal inks, with moderate electrical conductivities.

The conductive particles preferably have a mean particle size (d50) of from 0.5 to 30 μm, more preferably from 1 to 20 μm, even more preferably from 1.25 to 7 μm. The particle size may be determined, for example, using SEM, TEM, a laser scattering particle size analyser or a dynamic light scattering method. Such a particle size distribution may provide a favourable packing density, inter-particle interactions for targeted viscosity and electrical properties. The particular mean particle size may depend on the final application, for example fine line printing, thermoformable applications, e-textile, etc. and on the processing techniques.

The conductive particles preferably have a tap density of from 1 to 5 g/cc, more preferably from 1.5 to 4 g/cc. The tap density may be determined using a conventional tap density tester. The higher the tap density, the higher the percolation threshold for the electrical conductivity. Lower tap densities may make processing more difficult and may adversely affect the composition viscosity and rheology.

The conductive particles preferably have a surface area of from 0.3 to 2.1 m²/g or from 0.5 to 5 m²/g. This may make them more suitable for electronic applications. It may also help to provide the composition with favourable rheology and viscosity. The greater the surface area the greater the viscosity. Accordingly, higher surface areas may be more advantageous when the composition is used as a conductive adhesive, whereas lower surface areas may be more advantageous when the composition is used as a conductive ink. The surface area may be determined, for example, using a gas adsorption BET method.

The conductive particles preferably have an organic content of from 0.06 to 1.3 wt. % or from 0.01 to 3 wt. %. The organics may serve as an organic coating or capping agent. The organic coating may vary in chain length and may comprise a saturated or unsaturated fatty acid or ester, or a glycerol based derivative or amine or amide or phosphate or thiol. The organic coating may help the conductive particles to interact with polymers so as to remain in single phase. The organic content may be determined, for example by a gravimetric method. The amount of organic content on the filler particles (metal or metal oxide) are calculated by the loss of weight after heat treatment (200-700° C.).

The conductive particles preferably are in the form of one or more of flakes, spheres, irregularly shaped particles, nano-powders and nanowire. More preferably, the conductive particles are in the form of flakes. In comparison to spheres, flakes may have greater tendency for an interaction with the binder and adjacent particles. These features may help to achieve better adhesion to substrates and providing percolation threshold for the electrical conductivity.

Preferably, the conductive particles comprise a low level of:
ionics, more preferably substantially no ionics; and/or
free halogens, more preferably substantially no free halogens; and/or
deliberately added halogens, more preferably no deliberately added halogens.

In addition to the conductive fillers described above, the composition may preferably further comprise nano-sized silver particles or organo-silver compounds (AgMOC, such as silver neodecanoate and silver 2-ethylhexanoate). These may further enhance the electrical conductivities of the compositions.

The conductive fillers may comprise:
conducting, metallic nanowires (such as, for example, silver, copper, gold, palladium, platinum, silver-copper alloy, nickel, copper-nickel, silver coated copper, nickel coated copper); and/or
conducting carbon nanotubes and carbon nanofibers (such as, for example, conducting or semiconducting single walled carbon nanotubes, conducting or semiconducting multi-walled carbon nanotubes, conducting or semiconducting carbon nanofibers etc.); and/or
conducting polymers (such as, for example, polyaniline, PEDOT:PSS, polythiophene etc.); and/or
conducting graphene flakes.

Such conductive fillers may be particularly suitable for producing transparent conducting films, printed resistive heaters, transparent heaters, and transparent flexible and circuit elements. The present invention also provides the use of such conductive fillers to manufacture such objects.

The composition preferably comprises:
from 30 to 85 wt % binder, preferably from 40.1 to 80.9 wt. % binder, and
from 15 to 70 wt % conductive particles, preferably from 19.1 to 59.9 wt. % conductive particles.

Such amounts may provide a favourable level of conductivity together with the advantages of the binder described above.

In a preferred embodiment, the composition comprises:
from 30 to 85 wt % binder, preferably from 40.1 to 80.9 wt. % binder, and
from 15 to 70 wt % conductive particles, preferably from 19.1 to 59.9 wt. % conductive particles, and wherein the binder comprises:
from 0.2 to 6 wt. % cross-linking agent, preferably from 0.7 to 3.3 wt. % cross-linking agent,
from 1 to 7.5 wt. % polyurethane resin, preferably from 1.7 to 4.5 wt. % polyurethane resin,
from 0.1 to 5.5 wt. % polyester resin, preferably from 0.7 to 1.8 wt. % polyester resin,
from 1 to 7.5 wt. % phenoxy resin, preferably from 2.5 to 6.6 wt. % phenoxy resin,
from 0 to 10 wt. % thermosetting resin, preferably from 0 to 5.7 wt. % thermosetting resin (e.g. 0.1-5.7 wt. %),
from 0 to 1 wt. % curing catalyst, preferably from 0 to 0.6 wt. % curing catalyst (e.g. 0.1-0.6 wt. %),
from 0.2 to 10 wt % functional additives, preferably from 2.6 to 7.4 wt. % functional additives,
from 0 to 60 wt % glycol ether acetate, preferably from 4.3. to 43.2 glycol ether acetate,
from 0 to 40 wt % glycol ether, preferably from 0 to 24.1 wt. % glycol ether (e.g. 1-24.1 wt. %),
from 0 to 5 wt. % ester, preferably from 0 to 1.7 wt. % ester (e.g. 0.1-1.7 wt. %), and
from 0 to 30 wt % ketone, preferably from 0 to 20.5 wt. % ketone (e.g. 1-20.5 wt. %).

In a preferred embodiment, the composition is in the form of a conductive ink. In other words, the present invention provides a conductive ink comprising the composition described herein. The conductive inks may advantageously be used to make electrical flexible and formable circuits, interconnects, attach components and parts, via-fills, etc. The conductive ink may also be used for thermal connections. The conductive inks may exhibit viscosity and rheology suitable for printing using, for example, screen, stencil, gravure and flexographic techniques to produce electronics interconnect circuitries on various polymeric substrates, such as PC and PET. Once thermally dried and/or cured, interconnect lines, pattern shapes and/or features (for example, trace width, pad width etc.) produced using such inks may be controlled to >100 μm and possesses excellent surface resistance <100 Ω/□/mil (when various carbon particles are only used as conducting fillers) or <100 mΩ/□/mil (when various metallic particles and/or flakes are used as conducting fillers) and have adhesion (as per ASTM standard >3B) suitable for manufacturing of flexible electronics circuits. These interconnect circuits produced using such inks may possess excellent thermoformability and are stable under injection-molding ink wash-out, and thus suitable for IME manufacturing.

In a preferred embodiment, the composition is in the form of a conductive adhesive. In other words, the present invention provides a conductive adhesive comprising the composition described herein. The conductive adhesive may exhibit viscosity and rheology characteristics suitable for printing (screen and stencil), dispensing, jetting and micro-dispensing techniques for assembling various components, packages, and LEDs to interconnect circuits produced by earlier disclosed conducting inks on various polymeric substrates, such as PC and PET. Once thermally dried or cured, these interconnect lines and pattern shapes and features can be controlled to >50 μm and possesses excellent surface resistance <100 Ω/□/mil (when various carbon particles are only used as conducting fillers) or <100 mΩ/□/mil (when various metallic particles and/or flakes are used as conducting fillers) and having adhesion (as per ASTM standard >3B) suitable for manufacturing of flexible electronics circuits. Assembled components and packages produced using such conductive adhesives may show high mechanical stability as evident by die-shear results. Circuits produced using such conductive adhesives may possess excellent thermoformability and may be stable under injection-molding ink wash-out, and are thus suitable for IME manufacturing.

In a preferred embodiment, the composition further comprises non-conductive particles. Such compositions may be used to make, for example, electrical flexible and formable circuits, interconnects, attach components and parts, and via-fills. Such compositions may be used for mechanical and thermal connections.

The non-conductive particles preferably comprise organic non-conductive particles, preferably selected from one or more of cellulose, wax (for example, Ceraflour 991, Ceraflour 929 and Ceraflour 920 from BYK), polymer microparticles, non-conductive carbon particles and graphene oxide.

Alternatively, or in addition, the non-conductive particles preferably comprise inorganic non-conductive particles, preferably selected from one or more of mica, silica (SiO₂), fumed silica, talc, titanium dioxide (TiO₂), alumina, barium titanate (BaTiO₃) zinc oxide (ZnO) and boron nitride (BN), optionally wherein the inorganic non-conductive particles are submicron to micron sized (e.g. from 5 to 50000 nm, preferably from 10 to 30000 nm).

Organic non-conductive particles may increase the homogeneity of the composition but may have lower dielectric strength in comparison to inorganic non-conductive particles. Inorganic non-conductive particles may increase the dielectric strength but may result in decreased homogeneity in comparison to organic non-conductive particles. Thus, it may be preferable to functionalize the non-conductive particles with a functional group such as, for example, carboxylic acid, amine or alcohol to enable them to be better dispersed very well through interaction with the polymer system. The organic coating may vary in chain length and may comprise a saturated or unsaturated fatty acid or ester, or a glycerol based derivative or amine or amide or phosphate or thiol. This may also help to improve the long-term storage stability of the composition.

The non-conductive particles preferably exhibit a mean particle size (d50) from 1 to 30 μm or less than or equal to 10 μm. Higher ratio of very small particle size distributions increases the viscosity and makes the processing difficult, whereas presence of higher distribution of very larger particle size distributions lowers the viscosity, creates problem of slumping.

The non-conductive particles may be in the form of flakes and/or spheres and/or irregularly shaped particles. Preferably, the non-conductive particles are in the form of flakes and/or irregularly shaped particles. This is because, in comparison to spheres, flakes and irregularly shaped particles may have improved adhesion to a substrate and may have a reduced propensity to delaminate during a thermoforming process.

The non-conductive particles preferably have a low ionic content, preferably substantially zero.

Preferably, the non- conductive particles comprise a low level of:
ionics, more preferably substantially no ionics; and/or
free halogens, more preferably substantially no free halogens; and/or
deliberately added halogens, more preferably no deliberately added halogens.

The composition preferably comprises:
from 0 to 50 wt. % non-conductive particles, preferably from 2 to 45 wt. % non-conductive particles, and
from 50 to 100 wt. % binder, preferably from 55 to 98 wt. % binder.

Such amounts may provide a favourable level of dielectric properties together with the advantages of the binder described above.

In a preferred embodiment, the composition comprises:
from 40 to 100 wt. % binder, preferably from 50 to 98 wt. % binder, and
from 0 to 60 wt. % non-conductive particles, preferably from 2 to 50 wt. % non-conductive particles,

and the binder comprises:
from 0.5 to 10 wt % cross-linking agent, preferably from 1.9 to 6.1 wt. % cross-linking agent,
from 2 to 12 wt % polyurethane resin, preferably from 4.8 to 8.4 wt. % polyurethane resin,
from 0.5 to 10 wt. % polyester resin, preferably from 1.9 to 5.3 wt. % polyester resin,
from 2 to 18 wt % phenoxy resin, preferably from 4.5 to 12.4 wt. % phenoxy resin,
from 0 to 30 wt. % thermosetting resin, preferably from 0 to 19.6 wt. % thermosetting resin (e.g. 1-19.6 wt. %),
from 0 to 3 wt. % curing catalyst, preferably from 0 to 2 wt. % curing catalyst (e.g. 0.1-2 wt. %),
from 0.3 to 17 wt. % functional additives, preferably 1.4 to 12.5 wt. % functional additives,
from 0 to 60 wt. % glycol ether acetate, preferably from 4.9 to 41.7 wt. % glycol ether acetate,
from 0 to 60 wt. % glycol ether, preferably from 0 to 43.8 wt. % glycol ether (e.g. 1-43.8 wt. %),
from 0 to 30 wt. % ketone, preferably from 0 to 19.9 wt. % ketone (e.g. 1-19.9 wt. %),
from 0 to 50 wt. % alcohol, preferably from 0 to 35.5 wt. % alcohol (e.g. 1-35.5 wt. %), and
from 0 to 20 wt. % hydrocarbon, preferably from 0 to 13.3 wt. % hydrocarbon (e.g. 1-13.3 wt. %).

In a preferred embodiment, the composition is in the form of a dielectric ink. In other words, the present invention provides a dielectric ink comprising the composition described herein.

In a preferred embodiment, the composition is in the form of a non-conductive adhesive. In other words, the present invention provides a non-conductive ink comprising the composition described herein.

In a preferred embodiment, the composition is in the form of an encapsulant. In other words, the present invention provides an encapsulant comprising the composition described herein.

Once dried/cured, the binder of the dielectric ink, non-conductive adhesive and encapsulant may possess excellent dielectric properties and may be highly flexible and moderately stretchable, have superior adhesion and compatibility with other ink materials (e.g. silver and carbon) and substrates and have excellent weather resistance (moisture, gas and chemicals). The dielectric ink, non-conductive adhesive and encapsulant may possess excellent thermoformability and may be stable under injection-molding ink wash-out, thus be suitable for IME manufacturing. The viscosity and rheology of the dielectric ink, non-conductive adhesive and encapsulant may be suitable for printing using, for example, screen, stencil, gravure or flexographic techniques; spraying; dispensing; and jetting techniques to produce insulating layers for protecting conducting interconnect circuitries on various polymeric substrates, such as PC and PET. Once thermally dried or cured, the dielectric coating thickness can be controlled to >1 μm and may possess excellent dielectric break-down voltages (>100 V) and may have adhesion (as per ASTM standard >3B) suitable for manufacturing of flexible electronics circuits. The encapsulating coating layers may provide protection of conducting circuitries from environments, such as moisture and gasses.

The composition may preferably further comprise a colorant and/or dye and/or pigment, and may be the form of a graphic ink. In other words, the present invention provides a graphic ink comprising the composition described herein. The dye and/or pigment may form part of the functional additives discussed above.

In a further aspect, the present invention provides a method of manufacturing the composition described herein, the method comprising:
providing a solvent,
providing a thermoplastic resin having a hydroxyl group,
dissolving the thermoplastic resin in the solvent at a temperature of from 50 to 100° C., preferably from 70 to 100° C.,
cooling the solution to room temperature,
optionally adding to the cooled solution one or more of functional additives, thermosetting resins, curing catalysts for curing the thermosetting resins, conductive particles and non-contacting particles.

The advantages and preferably features of the first aspect apply equally to this aspect.

In a further aspect, the present invention provides a method of manufacturing an in-mould electronic (IME) component, the method comprising:
preparing a blank; and
thermoforming the blank,

wherein preparing the blank comprises forming one or more structures on a thermoformable substrate, each structure formed by a method comprising:
disposing the composition as described herein on a thermoformable substrate, and
drying the composition at a temperature of from 20 to 150° C. for from 1 to 30 minutes.

The term “thermoforming” as used herein may encompass a manufacturing process where a plastic sheet is heated to a pliable forming temperature, formed to a specific shape in a mold, and trimmed to create a usable product. The sheet is typically heated in an oven to a high-enough temperature that permits it to be stretched into or onto a mold and cooled to a finished shape. Its simplified version is vacuum forming. A pressure may be applied during the thermoforming. The thermoforming may comprise high-pressure thermoforming.

Drying the composition is carried out at a temperature of from 20 to 150° C., preferably from 30 to 130° C., for from 0.5 to 60 minutes, preferably for from 1 to 30 minutes.

Preferably two or more structures are formed. Use of the composition as disclosed herein ensures that the one or more structures, for example one or more layers in a multilayer stack, are compatible with each other.

The one or more structures are preferably selected from a conductive layer, a wire, a dielectric layer, an encapsulant layer, a graphic layer and a barrier layer.

The one or more structures preferably comprises a multilayer stack.

The one or more structures preferably comprises a printed circuit board.

Disposing the composition preferably comprises printing the composition, more preferably screen-printing the composition.

The substrate preferably comprises polycarbonate (PC) and/or polyethylene terephthalate (PET). The composition as described herein is compatible with, and forms strong adhesion with, such materials. Such materials also exhibit favourable thermoforming properties.

The thermoforming is preferably carried out at a temperature of from 140° C. to 210° C. Such a temperature is particularly suitable for thermoforming, and the composition described herein may be stable at such a temperature. The thermoforming may comprise vacuum thermoforming. In a preferred embodiment, the vacuum thermoforming is carried out at a pressure of from 0.25 MPa to 0.4 MPa. In another preferred embodiment, the high-pressure thermoforming is carried out at a pressure of from at a pressure ranging from 6 MPa to 12 MPa.

Preferably, the method further comprises attaching one or more electronic devices to the blank using a conductive adhesive or a non-conductive adhesive, the conductive adhesive being the composition described herein, wherein the attaching takes place before and/or after thermoforming.

Preferably, the method further comprises, after thermoforming, applying a layer of resin to the substrate using injection moulding, preferably wherein the resin comprises one or more of polycarbonate (PC), polyethylene terephthalate (PET), acrylonitrile butadiene styrene (ABS), polypropylene (PP), polyester, poly(methyl methacrylate) (PMMA), low density polyethylene (LDPE), high-density polyethylene (HDPE), polystyrene (PS), and thermoplastic polyurethane (TPU). Other similar resins may also be used. Such a layer of resin may provide the final IME component with favourable mechanical and/or aesthetic properties.

The injection moulding is preferably carried out at a temperature of from 170 to 330° C. Such a temperature is particularly suitable for injection moulding, and the composition described herein may be stable at such a temperature.

The in-mould electronic (IME) component preferably comprises a capacitive touch switch or a resistive touch switch. In comparison to conventional capacitive touch switches and resistive touch switches, such a capacitive touch switch and resistive touch switch may exhibit improved performance and/or reliability.

The in-mould electronic (IME) component preferably comprises one or more of a display, a light/lamp, a sensor, an indicator and a haptic/touch feedback device.

The in-mould electronic (IME) component preferably comprises one or more of a transparent conducting film, printed resistive heater, transparent resistive heater, transparent capacitive touch-based device, and transparent flexible and circuit element. In such case, preferably the composition comprises conductive fillers may comprising conducting, metallic nanowires and/or conducting carbon nanotubes and carbon nanofibers; and/or conducting polymers; and/or conducting graphene flakes, as described above.

In a further aspect, the present invention provides in-mould electronic (IME) component manufactured according to the method described herein. In comparison to conventional IME components, the IME component may exhibit improved performance and/or reliability.

In a further aspect, the present invention provides an in-mould electronic (IME) component comprising the composition described herein. As will be appreciated, the composition will have undergone at least partial cross-linking. In comparison to conventional IME components, the IME component may exhibit improved performance and/or reliability.

The in-mould electronic (IME) component preferably comprises a capacitive touch switch or a resistive touch switch. In comparison to conventional capacitive touch switches and resistive touch switches, such a capacitive touch switch and resistive touch switch may exhibit improved performance and/or reliability.

The in-mould electronic (IME) component preferably comprises one or more of a display, a light/lamp, a sensor, an indicator and a hepatic/touch feedback device. In comparison to conventional, display, a light/lamp, a sensor, an indicator and a hepatic/touch feedback device such a display, a light/lamp, a sensor, an indicator and a hepatic/touch feedback device may exhibit improved performance and/or reliability.

The in-mould electronic (IME) component preferably comprises one or more of a transparent conducting film, printed resistive heater, transparent resistive heater, transparent capacitive touch-based device, and transparent flexible and circuit element. In such case, preferably the composition comprises conductive fillers may comprise conducting, metallic nanowires and/or conducting carbon nanotubes and carbon nanofibers; and/or conducting polymers; and/or conducting graphene flakes, as described above.

The invention will now be further described by reference to the following numbered clauses:
1. A binder composition comprising:
   a thermoplastic resin comprising a hydroxyl group;
   a cross linker; and
   a solvent.
2. The binder composition of any preceding clause for use in a composition for electronic assembly.
3. The binder composition of clause 1 or clause 2 comprising:
   from 5 to 50 wt. %, preferably from 10 to 45 wt. %, more preferably from 10 to 40 wt. %, even more from preferably from 15 to 30 wt. % thermoplastic resin;
   from 0.1 to 5 wt. %, preferably from 1 to 4 wt. % cross linker; and
   from 45 to 85 wt. %, preferably from 50 to 80 wt. %, more preferably from 55 to 75 wt. % solvent.
4. The binder composition of any preceding clause, wherein the thermoplastic resin exhibits one or more of:
   a glass transition temperature <100° C. (preferably measured using DSC),
   a molecular weight in the range of 1000- 100000 g/mol (preferably measured using a viscosity technique),
   a softening point <100° C. (preferably measured according to ASTM-D1525), and
   a hydroxy content (OH number)>20 mgKOH/g (preferably measured according to ASTM E222-17).
5. The binder composition of any preceding clause, wherein the thermoplastic resin comprises one or more of a polyurethane resin, a polyester resin, a polyacrylate resin, a polyvinyl ester resin, a phenoxy resin and a ketonic resin.
6. The binder composition of clause 5 comprising:
   from 1 to 50 wt. % polyurethane resin (preferably from 10 to 30 wt. %, more preferably from 15 to 20 wt. %), and/or
from 1 to 30 wt. % polyester resin (preferably from 10 to 30 wt. %, more preferably from 15 to 20 wt. %), and/or
from 1 to 30 wt. % polyacrylate resin (preferably from 10 to 30 wt. %, more preferably from 15 to 20 wt. %), and/or
from 1 to 30 wt. % polyvinyl ester resin (preferably from 10 to 30 wt. %, more preferably from 15 to 20 wt. %), and/or
from 1 to 30 wt. % phenoxy resin (preferably from 10 to 30 wt. %, more preferably from 15 to 20 wt. %), and/or
from 1 to 30 wt. % ketonic resin (preferably from 10 to 30 wt. %, more preferably from 15 to 20 wt. %),
   preferably wherein the total amount of thermoplastic resin does not exceed 50 wt. %, more preferably 45 wt. %, still more preferably 40 wt. %.
7. The binder composition of clause 5, wherein the thermoplastic resin comprises:
   from 1 to 50 wt. % polyurethane resin (preferably from 10 to 30 wt. %, more preferably from 15 to 20 wt. %), and/or
from 1 to 30 wt. % polyester resin (preferably from 10 to 30 wt. %, more preferably from 15 to 20 wt. %), and/or
from 1 to 30 wt. % polyacrylate resin (preferably from 10 to 30 wt. %, more preferably from 15 to 20 wt. %), and/or
from 1 to 30 wt. % polyvinyl ester resin (preferably from 10 to 30 wt. %, more preferably from 15 to 20 wt. %), and/or
from 1 to 30 wt. % phenoxy resin (preferably from 10 to 30 wt. %, more preferably from 15 to 20 wt. %), and/or
from 1 to 30 wt. % ketonic resin (preferably from 10 to 30 wt. %, more preferably from 15 to 20 wt. %).
8. The binder composition of any preceding clauses comprising at least two thermoplastic resins comprising a hydroxyl group.
9. The binder composition of any preceding clause, wherein the cross linker is selected from one or more of a melamine resin, an amino resin, a polyamine resin, an isocyanate and a poly-isocyanate, preferably a melamine resin.
10. The binder composition of any preceding clause, wherein the solvent is selected from one or more of an alcohol, a glycol, a glycol ether, a glycol ester, an ester, and/or ketone solvent, and/or a hydrocarbon.
11. The binder composition of clause 8 comprising:
   from 1 to 55 wt. % alcohol solvent, and/or
from 1 to 50 wt. % glycol solvent, and/or
from 1 to 15 wt. % glycol ether solvent, and/or
from 1 to 60 wt. % glycol ester solvent, and/or
from 1 to 75 wt. % ester solvent, and/or
from 1 to 25 wt % ketone solvent, and/or
from 1 to 30 wt. % hydrocarbon solvent,
preferably wherein the total amount of alcohol solvent, glycol solvent, glycol ether solvent, glycol ester solvent, ester solvent, ketone solvent, and hydrocarbon solvent is not greater than 85 wt. %.
12. The binder composition of clause 8, wherein the solvent comprises:
   from 1 to 55 wt. % alcohol solvent, and/or
from 1 to 50 wt. % glycol solvent, and/or
from 1 to 15 wt. % glycol ether solvent, and/or
from 1 to 60 wt. % glycol ester solvent, and/or
from 1 to 75 wt. % ester solvent, and/or
from 1 to 25 wt % ketone solvent, and/or
from 1 to 30 wt. % hydrocarbon solvent.
13. The binder composition of any preceding clause, further comprising:
an acrylate resin together with one or more curing agents; and/or
an epoxy resins together with one or more curing agents.
14. The binder composition of clause 13 comprising: from 0.05 to 2 wt. %, preferably 0.1 to 1 wt. % curing agents and one or both of:
from 0.1 to 20 wt. %, preferably from 1 to 10 wt. % acrylate resins; and
from 0.1 to 20 wt. %, preferably from 1 to 10 wt. % epoxy resins.
15. The binder composition of any preceding clause, wherein the binder composition is thermoformable.
16. The binder composition of any preceding clause, wherein the binder composition is thermal curable.
17. The binder composition of any preceding clause, wherein the thermoplastic resin is capable of forming a nitrogen-carbon bond with the cross linker.
18. A composition for electronic assembly comprising: the binder composition of any preceding clause, and filler particles.
19. The composition for electronic assembly of clause 18 comprising:
   from 30 to 99 wt. %, preferably from 30 to 98 wt. % binder composition (alternatively from 30 to 55 wt. %, preferably 30 to 50 wt. % binder composition); and
   from 1 to 40 wt. %, preferably from 2 to 40 wt. % (alternatively from 45 to 70 wt. %, preferably from 50 to 70 wt. % conducting filler particles, or from 5 to 40 wt. % filler particles, typically non-conducting filler particles).
20. The composition for electronic assembly of clause 18 or clause 19, wherein the filler particles comprise a filler such as a metal or a non-metal (typically a conducting filler) or filler, such as metal oxide or non-metal or organic polymeric materials (typically a non-conducting filler).
21. The composition for electronic assembly of any of clauses 18 to 20, wherein the filler particles (typically conducting filler particles) comprise one or more of silver, silver alloy, copper, copper alloy (e.g. CuNi, CuZn and CuNiZn), silver-coated copper, silver-coated copper alloy, graphene, carbon black, carbon nanotube, graphite, silver-coated graphene and silver-coated graphite.
22. The composition for electronic assembly of any of clauses 18 to 21, wherein the filler particles (typically non-conducting filler particles) comprise one or more of cellulose, wax, polymer, mica, silica, talc, alumina, barium titanate, carbon particles (typically non-conducting carbon particles), graphene oxide and boron nitride.
23. The composition for electronic assembly of any of clauses 18 to 22, wherein the filler particles have a D50 of from 1 to 30 μm, preferably from 2 to 20 μm, preferably measured using SEM and/or a laser scattering particle size analyser.
24. The composition for electronic assembly of any of clauses 18 to 23, wherein at least some of the filler particles, preferably substantially all of the filler particles, have a flake-like shape, preferably in which a ratio of the longest dimension of the particle to the shortest dimension of the particle is greater than 1, more preferably greater than 2, even more preferably from 2 to 10.
25. The composition for electronic assembly of any of clauses 18 to 24, wherein the filler particles have a tap density of 1 to 5.
26. The composition for electronic assembly of any of clauses 18 to 25, wherein the filler particles are capped with a capping agent.
27. The composition for electronic assembly of any of clauses 18 to 26, wherein the filler particles have a surface area of from 0.5 to 5 m²/g.
28. The composition for electronic assembly of any of clauses 18 to 27 in the form of a metallic ink, a non-metallic ink or a conductive adhesive.
29. The composition for electronic assembly of any of clauses 18 to 28 in the form of a dielectric ink, a non-conducting ink or a nonconductive adhesive or an encapsulant.
30. The composition for electronic assembly of any of clauses 18 to 29 printed on a polymer substrate, such as polycarbonate (PC), polyethylene terephthalate (PET), and/or thermoformed to form curved, 2.5D and 3D structures.
31. The composition for electronic assembly of any of clauses 18 to 30 printed on a suitable polymer substrate, such as polycarbonate (PC), polyethylene terephthalate (PET), thermoformed to form curved, 2.5D and 3D structures, injection molded to form in-mold electronics (IME) and similar structures.
32. The composition for electronic assembly of any of clauses 18 to 31 capable of being printed on a suitable graphic ink or decorative ink, which have been applied on to a polymer substrate, such as polycarbonate (PC), polyethylene terephthalate (PET), and capable of being thermoformed to form curved, 2.5D and 3D structures.

33. The composition for electronic assembly of any of clauses 18 to 32 printed on a suitable graphic ink or decorative ink, which have been applied on to a polymer substrate, such as polycarbonate (PC), polyethylene terephthalate (PET), can be thermoformed to form curved, 2.5D and 3D structure, injection molded to form in-mold electronics (IME) and similar structures.
34. The composition for electronic assembly of any of clauses 18 to 33 are compatible with each-other, have sufficient adhesion, thermoformable and are resistant to ink wash-out during injection molding.
35. Use of the composition for electronic assembly of any of clauses 18 to 34 in the manufacture of an in-mold electronics structure (IME).
36. A method of manufacturing an in-mold electronics structure (IME), the method comprising:
   providing the composition for electronic assembly of any of clauses 18 to 34 between a polymer substrate and an electronic component to form an electronic structure,
   thermoforming the structure to form a thermoformed structure, and
   injection molding the thermoformed structure.
37. The method of clause 36, wherein the thermoforming is carried out at a temperature of from 140 to 180° C.
38. The method of clause 36 or clause 37, wherein the injection molding is carried out at a temperature of from 200 to 330° C.
39. The method of any of clauses 36 to 38, wherein the polymer substrate: is flexible, and/or
comprises polycarbonate (PC) and/or polyethylene terephthalate (PET), and/or has graphic ink on the surface thereof.
40. The method of any of clauses 36 to 39, wherein the polymer substrate is coated with one or more of:
   an ink (preferably a graphic or decorative ink),
   a non-conducting layer (preferably formed form a non-conducting ink),
a dielectric layer, and
an outer layer in the form of a circuit formed of (or from) conductive ink.
41. The method of any of clauses 36 to 40, wherein providing the composition between a polymer substrate and an electronic component to form a structure comprises screen printing the composition and/or drying or curing the composition.
42. The method of any of clauses 36 to 41, wherein the in-mold electronics structure is curved, 2.5D or 3D.
43. A binder composition comprising:
a thermoplastic resin comprising a hydroxyl group;
a cross linker; and
a solvent; and/or
acrylate resins with one or more curing agents; and/or
epoxy resins with one or more curing agents.
44. The binder composition of any preceding clause for use in a composition for electronic assembly.
45. The binder composition of clause 43 or clause 44 comprising:
   from 5 to 45 wt. %, preferably from 10 to 40 wt. %, more from preferably 15 to 30 wt. % thermoplastic resin;
   from 0.1 to 5 wt. %, preferably from 1 to 4 wt. % cross linker; and
from 0.1 to 20 wt. %, preferably from 1 to 10 wt. % acrylate resins; and/or
from 0.1 to 20 wt. %, preferably from 1 to 10 wt. % epoxy resins; and
from 0.05 to 2 wt. %, preferably 0.1 to 1 wt. % curing agents; and
from 45 to 85 wt. %, preferably from 50 to 80 wt. %, more preferably from 55 to 75 wt. % solvent.
46. The binder composition of any preceding clause, wherein the thermoplastic resin exhibits one or more of:
a glass transition temperature <100° C.,
a molecular weight in the range of 1000-100000 g/mol
a softening points <100° C., and
a hydroxy content (OH number)>20 mgKOH/g.
47. The binder composition of any preceding clause, wherein the thermoplastic resin comprises one or more of a polyurethane resin, a polyester resin, a polyacrylate resin, a polyvinyl ester resin, a phenoxy resin and a ketonic resin.
48. The binder composition of any of clauses 43 to 47, comprising:
   from 1 to 50 wt. % polyurethane resin, and/or
from 1 to 30 wt. % polyester resin, and/or
from 1 to 30 wt. % polyacrylate resin, and/or
from 1 to 30 wt. % polyvinyl ester resin, and/or
from 1 to 30 wt. % phenoxy resin, and/or
from 1 to 30 wt. % ketonic resin, and/or
from 1 to 75 wt. % acrylate resin, and/or
from 1 to 75 wt. % epoxy resin.
49. The binder composition of any preceding clause, wherein the cross linker is selected from one or more of a melamine resin, an amino resin, a polyamine resin, an isocyanate and a poly-isocyanate, preferably a melamine resin.
50. The binder composition of any preceding clause, wherein the curing agent is selected from one or more of a thermal curing initiator and/or UV curing initiator.
51. The binder composition of any preceding clause, wherein the solvent is selected from one or more of an alcohol, a glycol, a glycol ether, a glycol ester, an ester, and/or ketone solvent, and/or a hydrocarbon.
52. The binder composition of clause 51 comprising:
from 1 to 50 wt. % alcohol solvent, and/or
from 1 to 50 wt. % glycol solvent, and/or
from 1 to 15 wt. % glycol ether solvent, and/or
from 1 to 60 wt. % glycol ester solvent, and/or
from 1 to 75 wt. % ester solvent, and/or
from 1 to 25 wt % Ketones, and/or
from 1 to 30 wt. % hydrocarbon solvent.
53. The binder composition of any preceding clause, wherein the binder composition is thermal curable.
54. The binder composition of any preceding clause, wherein the binder composition is UV curable.
55. The binder composition of any preceding clause, wherein the binder composition is thermoformable.
56. The binder composition of any preceding clause, wherein the thermoplastic resin is capable of forming a nitrogen-carbon bond with the cross linker.
57. A composition for electronic assembly comprising:
   the binder composition of any of clause 43 to 56, and
   filler particles.
58. The composition of clause 57 comprising:
   from 30 to 99 wt. %, preferably from 30 to 99 wt. % binder composition; and
   from 45 to 70 wt. %, preferably from 50 to 70 wt. % conducting filler particles, or from 1 to 40 wt. %, preferably from 2 to 40 wt. % or from 5 to 40 wt. % non-conducting filler particles.
59. The composition of clause 57 or clause 58, wherein the filler particles comprise a conducting, such as metal or a non-metal or non-conducting, such as metal oxide or non-metal or organic polymeric materials.
60. The composition of any of clauses 57 to 59, wherein the conducting filler particles comprise one or more of silver, silver alloy, copper, copper alloy (e.g. CuNi, CuZn and CuNiZn), silver-coated copper, silver-coated copper alloy, graphene, graphite, carbon black, carbon nanotube, silver-coated graphene and silver-coated graphite.
61. The composition of any of clauses 57 to 60, wherein the non-conducting filler particles comprise one or more of cellulose, wax, polymer, mica, silica, talc, alumina, barium titanate, non-conducting carbon particles, graphene oxide and boron nitride.
62. The composition of any of clauses 57 to 61, wherein the filler particles have a D50 of from 1 to 30 μm, preferably from 2 to 20 μm, preferably measured using SEM and/or laser scattering particle size analyser.
63. The composition of any of clauses 57 to 62, wherein at least some of the filler particles, preferably substantially all of the filler particles, have a flake-like shape, preferably in which a ratio of the longest dimension of the particle to the shortest dimension of the particle is greater than 1, more preferably greater than 2, even more preferably from 2 to 10.
64. The composition of any of clauses 57 to 63, wherein the filler particles have a tap density of 1 to 5.
65. The composition of any of clauses 57 to 64, wherein the filler particles are capped with a capping agent.
66. The composition of any of clauses 57 to 65, wherein the filler particles have a surface area of from 0.5 to 5 m²/g.
67. The composition of any of clauses 57 to 66 in the form of a metallic ink, a non-metallic ink or a conductive adhesive.
68. The composition of any of clauses 57 to 67 in the form of a dielectric ink, a non-conducting ink or a nonconductive adhesive or an encapsulants.
69. Use of the composition of any of clauses 57 to 67 in the manufacture of an in-mold electronics structure (IME).
70. A method of manufacturing an in-mold electronics structure (IME), the method comprising:
   providing the composition of any of clauses 57 to 68 between a polymer substrate and an electronic component to form a structure,
   thermoforming the structure to form a thermoformed structure, and
   injection molding the thermoformed structure.
71. The method of clause 70, wherein the thermoforming is carried out at a temperature of from 140 to 180° C.
72. The method of clause 70 or clause 71, wherein the injection molding is carried out at a temperature of from 200 to 330° C.
73. The method of any of clauses 70 to 72, wherein the polymer substrate: is flexible and/or comprises polycarbonate (PC) and/or polyethylene terephthalate (PET).
74. The method of any of clauses 70 to 73, wherein providing the composition between a polymer substrate and an electronic component to form a structure comprises screen printing the composition and/or drying or curing the composition.
75. An Electronics structure comprising of; a polymer substrate, with/without coated with graphic or decorative ink, coated with a non-conducting or a dielectric layer, followed by application of conducting inks to form circuits, where in electronics component are attached using conducting adhesive; the structure is thermoformed; and/or structure is injection molded to produce a part.
76. A method of manufacturing an electronics structure of clause 75, the method comprising:
   providing of non-conducting or dielectric ink compositions of any of clauses 13 to 23 or 44 to 54 on a polymer substrate with/without coated with graphic or decorative ink; and
Screen printing of conducting ink composition of any of clauses 13 to 23 or 44 to 54 on a non-conducting ink coated polymer substrate;
and placing an electronic component, attached using a suitable conductive and non-conductive adhesive of any clause 13 to 23 and 44 to 54 to form an electronic structure;
   thermoforming the structure to form a thermoformed structure, and
   injection molding the thermoformed structure.
77. The method of clause 76, wherein the thermoforming is carried out at a temperature of from 140 to 180° C.
78. The method of clause 76 or clause 77, wherein the injection molding is carried out at a temperature of from 200 to 330° C.
79. The method of any of clauses 76 to 78, wherein the polymer substrate: is flexible and/or comprises polycarbonate (PC) and/or polyethylene terephthalate (PET).
80. The method of any of clauses 76 to 79, wherein the polymer substrate: is flexible and/or comprises graphic ink coated polycarbonate (PC) and/or polyethylene terephthalate (PET).
81. The method of any of clauses 76 to 80, wherein providing the composition between a polymer substrate and an electronic component to form a structure comprises screen printing the composition and/or drying or curing the composition.
82. An in-mold electronics structure (IME) manufactured according to the method of any of clauses 36 to 42 or 70 to 81.

The invention will now be described in relation to the following non-limiting drawings in which:

FIG. 1 shows a schematic representation of generic manufacturing process steps of In-mold Electronics Structures (IME).

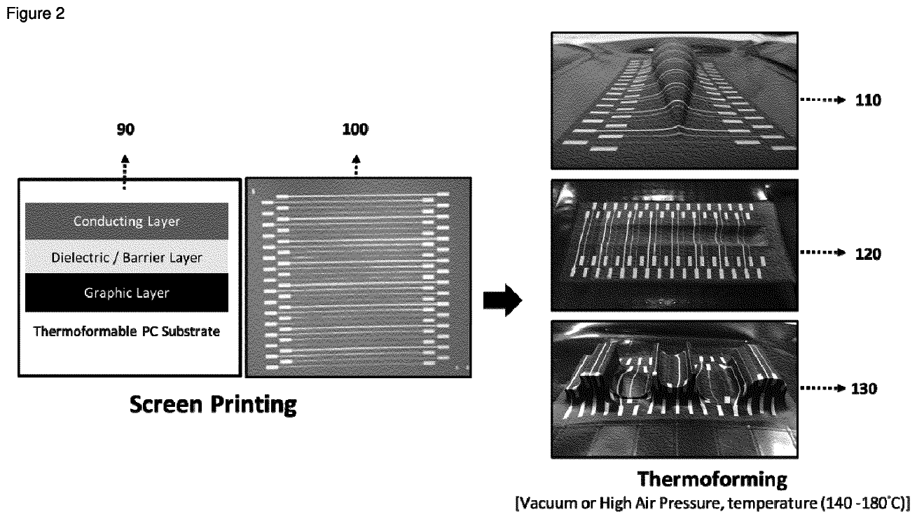

FIG. 2 shows a schematic diagram of ink stacks on the thermoformable PC substrate with different materials: Stack of Screen-Printed Silver Layer//Dielectric Layer//Graphic Layer coated Thermoformable PC substrate (90) and an image of an actual sample prepared using Example 1 (Silver Ink) an Example 47 (Dielectric Ink) on a black graphic ink coated thermoformable PC substrate (100), which produced structures 110, 120 and 130 upon thermoforming.

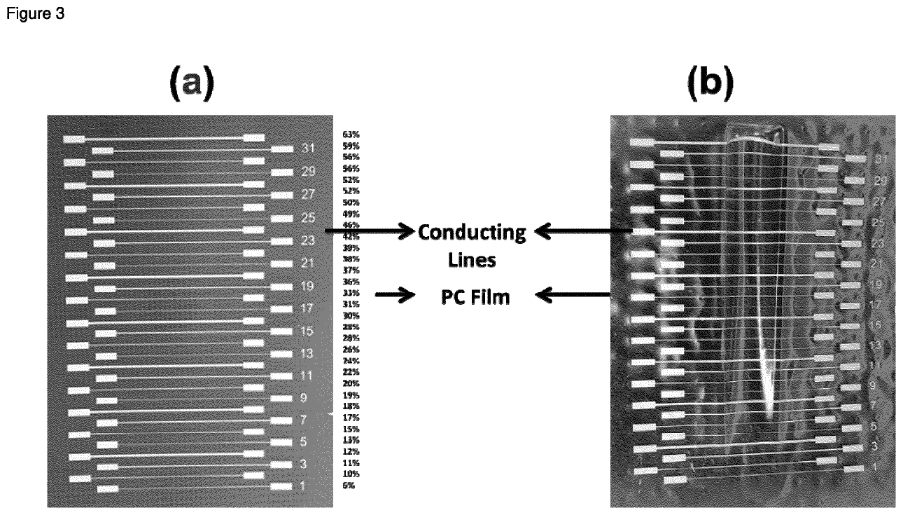

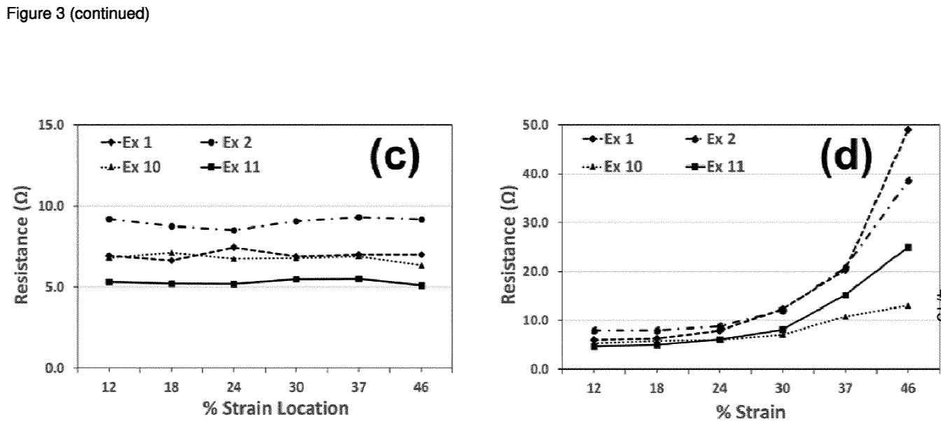

FIG. 3 shows (a and b) representative optical images of a typical thermoformability test sample before and after thermoforming, respectively, as per the ‘Cone Formability Test Procedure’; (c and d) variation of electrical resistance of conducting Silver circuit traces of 1000 μm line width prepared using silver inks (Example 1, Example 2, Example 10 and Example 11), before and after thermoforming, respectively, as function of strain%.

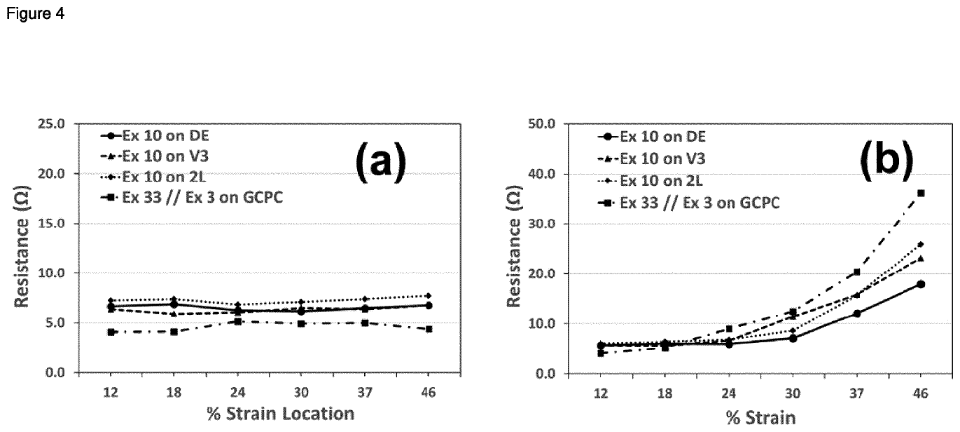

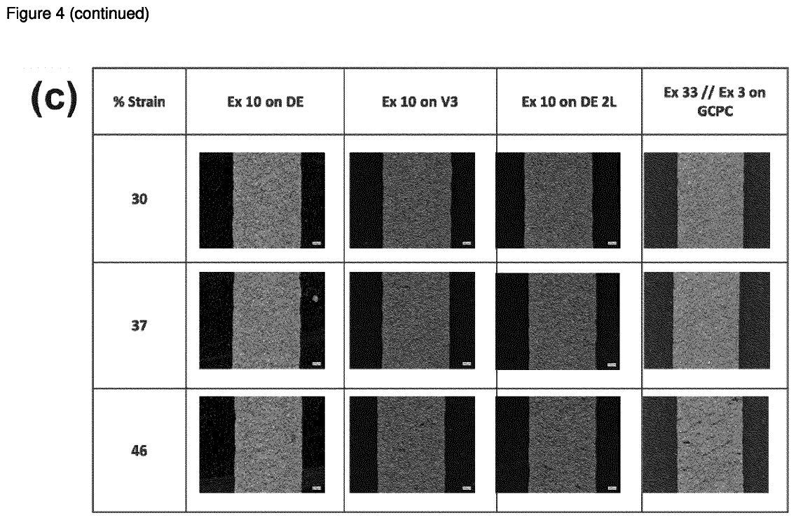

FIG. 4 shows (a and b) variation of electrical resistance of conducting Silver circuit traces of 1000 μm line width prepared using Silver Ink (Example 10) on various PC substrates, before and after thermoforming, respectively, as function of strain % as per the ‘Cone Formability Test Procedure’. FIG. 4(c) shows microscopic images of the conducting silver circuit traces of 1000 μm line width at 0, 30, 37 and 46% strain for the test samples as shown in FIG. 4(b).

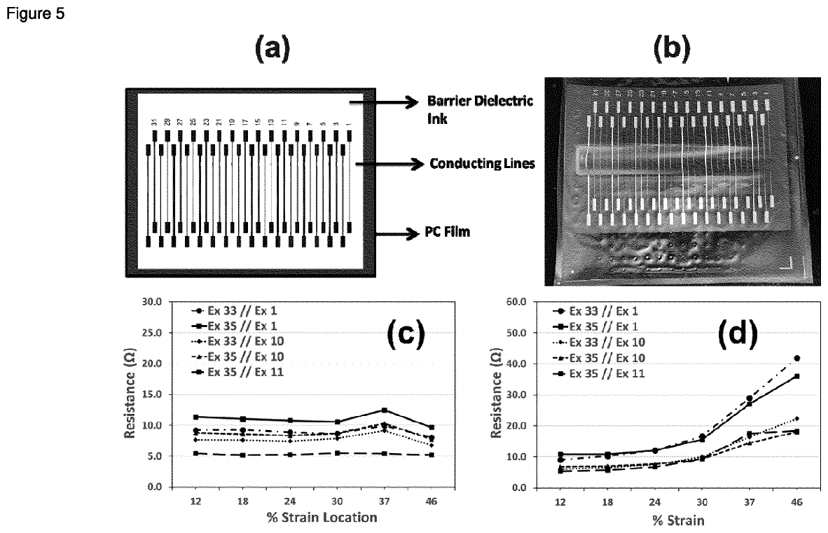

FIG. 5 shows (a and b) representative optical images of a typical “two-stack” prepared using Dielectric and Silver Inks, thermoformability test sample before and after thermoforming, respectively, as per the ‘Cone Formability Test Procedure’; (c and d) Variation of electrical resistance of conducting Silver circuit traces of 1000 pm line width of Silver Ink (Example 1) printed on Dielectric Ink (Example 33 & 35), Silver Ink Example 10 printed on Dielectric Ink (Example 33 & 35) and Silver Ink (Example 11) printed on Dielectric Ink (Example 35), before and after thermoforming, respectively.

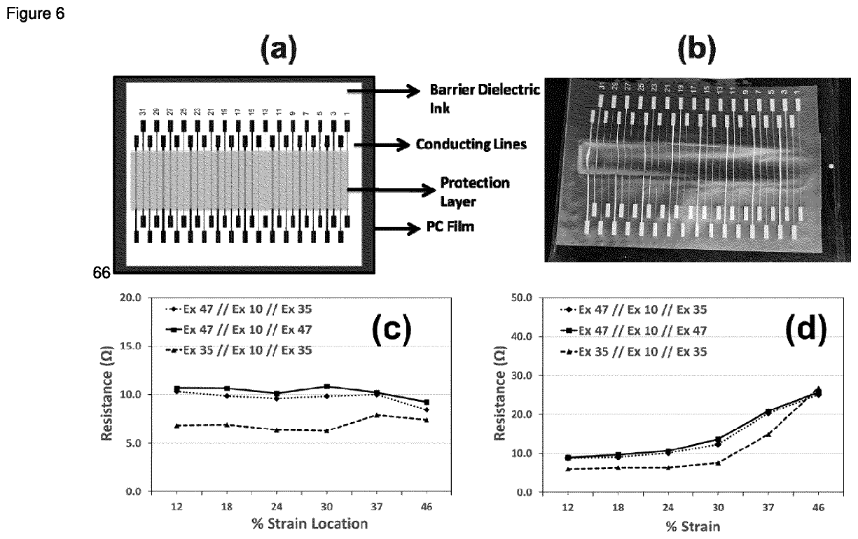

FIG. 6 shows (a and b) representative optical images of a typical “three-stack” prepared using Dielectric and Silver Inks, thermoformability test sample before and after thermoforming, respectively, as per the ‘Cone Formability Test Procedure’; (c and d) Variation of electrical resistance of conducting circuit traces of 1000 μm line width of Silver Ink (Example 10), where Barrier Dielectric layer and Protection layers were selected either as Example 35 or Example 47 or their combinations.

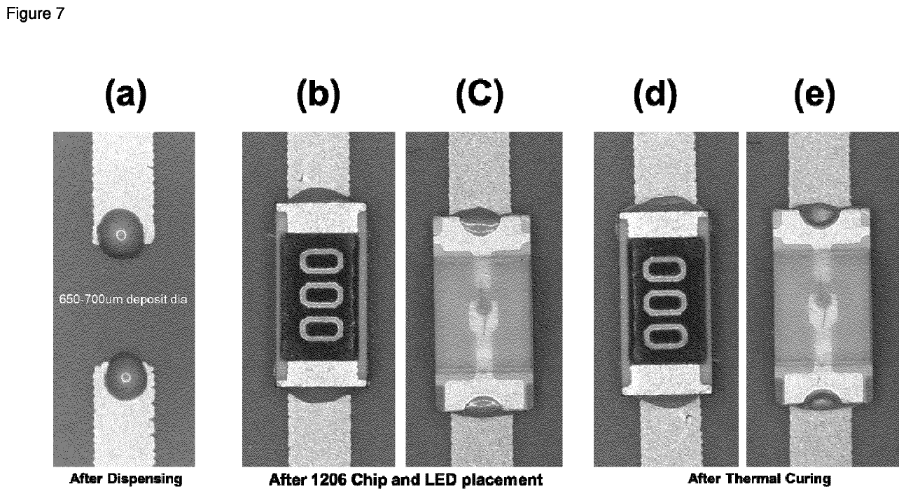

FIG. 7 shows representative application of a thermoformable conductive adhesive composition (Example 7) for the attachment of SMD components on formable conducting Silver circuit traces (Example 10); (a) microscopic image of the dispensed dots (wet deposit); (b & c) microscopic images of the wet assembly of SMD 1206 chip and SMD 1206 LED, respectively on formable conducting Silver circuit traces (Example 10); (d & e) thermally cured and dried formed of (b) and (c).

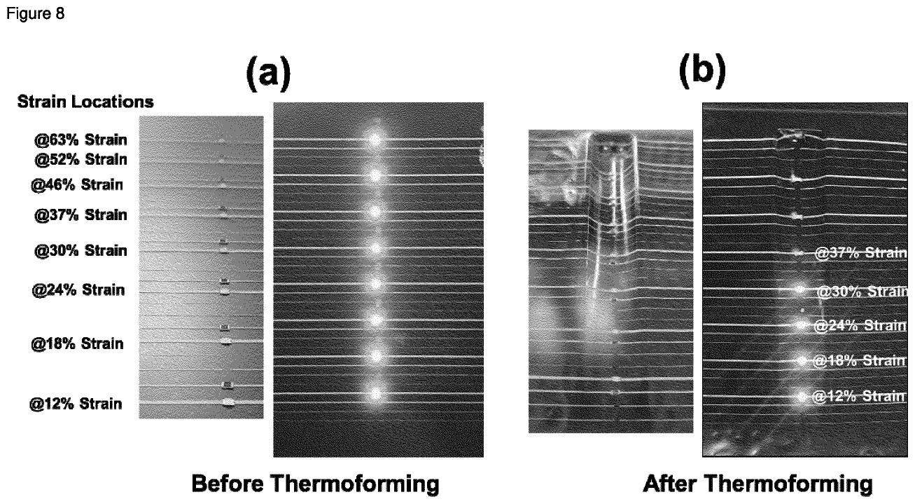

FIG. 8 shows representative optical images of a typical thermoformability test sample (a) before and (b) after thermoforming, respectively, as per the ‘Cone Formability Test Procedure. Thermoformable conductive adhesive (Example 7) has been used for the attachment of SMD 1206 chip and SMD 1206 LED on formable conducting Silver circuit traces (Example 10). Lightened LEDs on printed conductive tracks (a) before and (b) after thermoforming experiments, indicative of continuity of the circuit structures and corresponding stain locations.

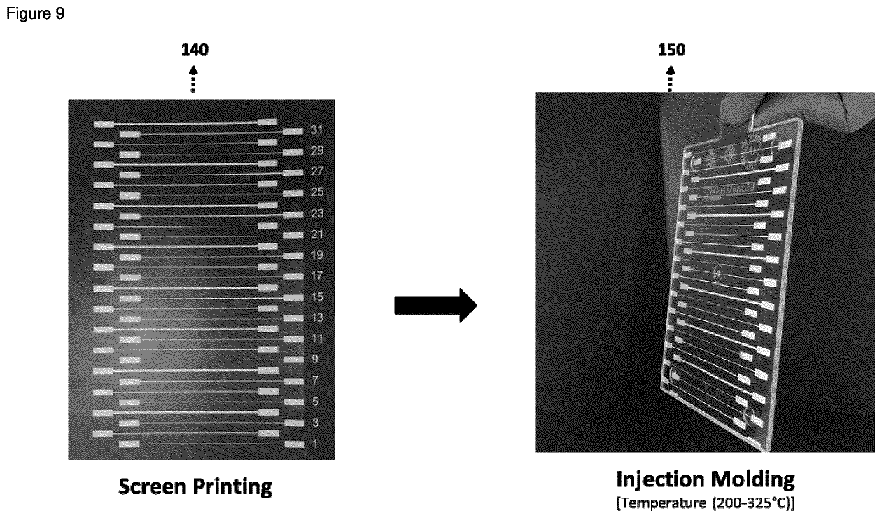

FIG. 9 shows a representative stack of Screen-Printed Silver Layer II Thermoformable PC substrate (140), which produced structure 150 upon injection molding.

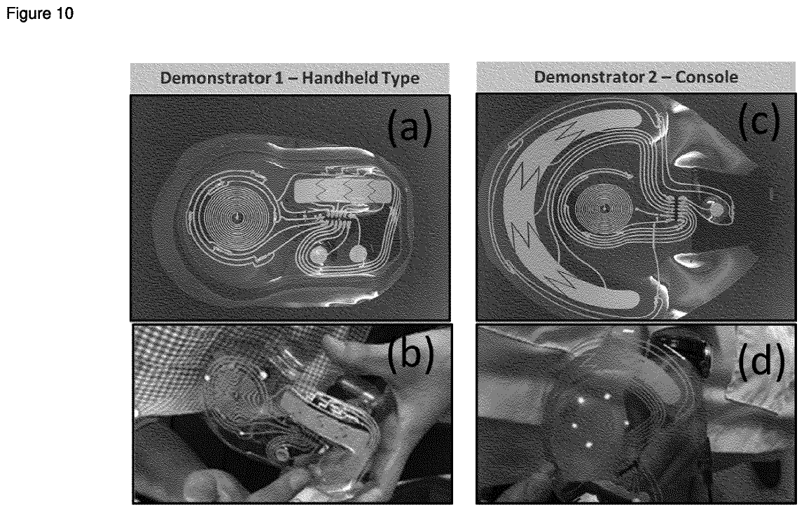

FIG. 10 shows representative design and construction of functional 3D electronic device; (a and b) are images of Handheld Type and (c and d) are Console types of Demonstrators capable of performing touch switching applications; produced by screen printing and drying of Example 1, followed attaching LED using Example 1 and then thermoforming the whole stack.

FIG. 11 shows (a) a representative fully functional IME device, which can be viewed as a protype of a typical Airplane Console panel in switched off condition; (b) Demonstrate the capacitive touch switching applications of such IME demonstrator.

The invention will now be described in relation to the following non-limiting examples.

Key attributes of various fillers (conductive and non-conductive) used in the examples are set out in Table 1 below.

TABLE 1

| | | | | | Mean |
|---|---|---|---|---|---|
| | | | | | Particle |
| | | Tap | Surface | Organic | Size |
| | | Density | Area | Content | (d50), |
| Filler Type | Filler Name | (g/cc) | (m²/g) | (wt %) | μm |
| Conducting | Silver Flake 1 | 3.5 | 1.01 | 0.57 | 4.4 |
| Filler | Silver Flake 2 | 3.2 | 1 | 0.42 | 7 |
| | Silver Flake 3 | 3.1 | 1.55 | 0.63 | 3.7 |
| | Silver Flake 4 | 2 | 2.1 | 1.31 | 1.5 |
| | Silver Flake 5 | 3.3 | 1.49 | 0.55 | 1.25 |
| | Ag Coated | 4 | 0.47 | 0.07 | 4.5 |
| | Copper Flake | | | | |
| | Ag Coated | 3.7 | 0.43 | 0.06 | 3.5 |
| | Brass Flake | | | | |
| | Nano Silver | | | <1 | 0.03-0.1 |
| | Ag Coated | <4 | 0.47 | <0.1 | 4.5 |
| | Copper Flake | | | | |
| | Ag Coated | <4 | 0.43 | <0.1 | 3.5 |
| | Brass Flake | | | | |
| | Graphite Flake | | 11.25 | <0.8 | 7.75 |
| | Graphene Powder | | 30-50 | | 5 |
| Non- | Talc Powder | | | | 5.1 |
| conducting | Titanium | | | <0.5 | 0.4 |
| Filler | Dioxide Powder | | | | |
| | Boron Nitride | 0.35 | | | 10 |
| | Powder | | | | |
| | Barium Titanate | | 2.1 | <0.5 | 1.3 |
| | Powder | | | | |
| | Silica Powder | | | | 5 |
| | Ceraflour 920 | | | | 5 |
| | Ceraflour 929 | | | | 8 |
| | Ceraflour 991 | | | | 5 |

### Examples of Conductive Inks and Compositions

Several compositions were prepared by dissolving mixture of thermoplastic polyester resins, polyurethane resins and phenoxy resins having hydroxyl functional groups in mixture of different category of solvents at 70-100° C. The reaction mixtures were cooled to room temperature followed by addition of functional additive package, containing surfactants, rheology modifier, dispersants, defoaming agents and wetting agents. Reactive cross-linkers and/or other acrylics or epoxy curing agents were then mixed well with the above polymer resin mixtures. The compositions were further mixed with several different conductive particles for the preparation of conductive inks, coatings and adhesive compositions. The conductive particles were mixed using an orbital mixer (1000 rpm for 1 min for 3 cycles). Certain compositions were also milled in a three-roll mill for a few minutes to obtain to obtain a homogeneous paste.

Example 1 to Example 14 and Example 19 to Example 26 below are conductive compositions prepared without a thermosetting resin. Example 15 to Example 18 are conductive compositions prepared using a thermosetting resin and corresponding curing catalyst.

### Example 1

| Category of Raw Materials | Chemical Name | Weight % |
|---|---|---|
| Cross-linker | Maprenel MF650 | 1.4 |
| | (55% in isobutanol) | |
| Thermoplastic | Dynapol L-411 | 1.4 |
| Polyester Resin | | |
| Thermoplastic | Desmomelt 540/1 | 3.4 |
| Polyurethane Resin | | |
| Thermoplastic | PKHH | 5.0 |
| Phenoxy Resin | | |
| Functional Additives | Functional Additives | 2.7 |
| Glycol Ether Acetate | Eastman DE Acetate | 22.3 |
| Ketone | C11-Ketone | 10.7 |
| Conductive Filler | Silver Flake 1 | 53.2 |
| Total | | 100.0 |

53.2 weight % of Silver flake and 46.8 weight % of polymer solution of was mixed together using an orbital mixer at 1000 rpm for 1 min for 3 cycles to obtain a homogeneous paste. The viscosity of the paste was found to be in the range of 4000-7000 cP and is suitable for the screen printing.

### Examples 2-26

Compositions having the components specified in Tables 2-6 below were prepared as per the process described in Example 1 above.

TABLE 2
Chemical composition of Example 1 to Example 5.

| | | Ex- | Ex- | Ex- | Ex- | Ex- |
|---|---|---|---|---|---|---|
| Category of | Chemical | ample | ample | ample | ample | ample |
| Raw Materials | Name | 1 | 2 | 3 | 4 | 5 |
| Cross-linker | Maprenel | 1.4 | 1.4 | 1.4 | 1.3 | 1.4 |
| | MF650 (55% | | | | | |
| | in isobutanol) | | | | | |
| Thermoplastic | Dynapol L-411 | 1.4 | 1.4 | 1.4 | 1.3 | 1.4 |
| Polyester Resin | | | | | | |
| Thermoplastic | Desmomelt | 3.4 | 3.5 | 3.5 | 3.2 | 3.5 |
| Polyurethane Resin | 540/1 | | | | | |
| Thermoplastic | PKHH | 5.0 | 5.1 | 5.1 | 4.7 | 5.1 |
| Phenoxy Resin | | | | | | |
| Functional | Functional | 2.7 | 5.7 | 5.7 | 5.3 | 5.7 |
| Additives | Additives | | | | | |
| Glycol Ether | Eastman DE | 22.3 | 23.0 | 23.0 | 26.8 | 23.0 |
| Acetate | Acetate | | | | | |
| Glycol Ether | Eastman DB | — | 5.4 | 5.4 | 6.3 | 5.4 |
| | Solvent | | | | | |
| Ketone | C11-Ketone | 10.7 | — | — | — | — |
| Conductive Filler | Ag Flake 1 | 53.2 | 54.6 | — | — | — |
| Conductive Filler | Ag Flake 2 | — | — | 46.4 | — | — |
| Conductive Filler | Ag Flake 4 | — | — | 8.2 | 51.1 | — |
| Conductive Filler | Ag Flake 5 | — | — | — | — | 54.6 |

| | | | | | |
|---|---|---|---|---|---|
| Total | 100.0 | 100.0 | 100.0 | 100.0 | 100.0 |

TABLE 3
Chemical composition of Example 6 to Example 10.

| | | Ex- | Ex- | Ex- | Ex- | Ex- |
|---|---|---|---|---|---|---|
| Category of | Chemical | ample | ample | ample | ample | ample |
| Raw Materials | Name | 6 | 7 | 8 | 9 | 10 |
| Cross-linker | Maprenel | 1.8 | 1.5 | 1.4 | 1.4 | 1.4 |
| | MF650 (55% | | | | | |
| | in isobutanol) | | | | | |
| Thermoplastic | Dynapol L-411 | 1.8 | 1.5 | 1.4 | 1.4 | 1.4 |
| Polyester Resin | | | | | | |
| Thermoplastic | Desmomelt | 4.5 | 3.8 | 3.5 | 3.5 | 3.4 |
| Polyurethane | 540/1 | | | | | |
| Resin | | | | | | |
| Thermoplastic | PKHH | 6.6 | 5.5 | 5.1 | 5.1 | 5.0 |
| Phenoxy Resin | | | | | | |
| Functional | Functional | 7.4 | 6.2 | 5.7 | 5.7 | 5.6 |
| Additives | Additives | | | | | |
| Glycol Ether | Eastman DE | 16.5 | 17.4 | — | — | 2.8 |
| Acetate | Acetate | | | | | |
| Glycol Ether | Propylene | — | — | 8.5 | 4.3 | 4.2 |
| Acetate | glycol | | | | | |
| | monomethyl | | | | | |
| | ether acetate | | | | | |
| Glycol Ether | Downol PPH | — | — | — | 4.3 | 2.8 |
| Glycol Ether | Eastman DB | 3.9 | 4.1 | 19.9 | 19.9 | 19.6 |
| | Solvent | | | | | |
| Conductive Filler | Ag Flake 1 | — | — | 54.6 | 54.6 | 53.9 |
| Conductive Filler | Ag Flake 3 | 57.4 | 51.0 | — | — | — |
| Conductive Filler | Ag Flake 4 | — | 8.9 | — | — | — |

| | | | | | |
|---|---|---|---|---|---|
| Total | 100.0 | 100.0 | 100.0 | 100.0 | 100.0 |

TABLE 4
Chemical composition of Example 11 to Example 16.

| | | Ex- | Ex- | Ex- | Ex- | Ex- | Ex- |
|---|---|---|---|---|---|---|---|
| Category of | Chemical | ample | ample | ample | ample | ample | ample |
| Raw Materials | Name | 11 | 12 | 13 | 14 | 15 | 16 |
| Cross-linker | Maprenel | 1.4 | 1.4 | 1.4 | 1.4 | 0.7 | 0.7 |
| | MF650 | | | | | | |
| | (55% in | | | | | | |
| | isobutanol) | | | | | | |
| Thermoplastic | Dynapol | 1.4 | 1.4 | 1.4 | 1.4 | 0.7 | 0.7 |
| Polyester Resin | L-411 | | | | | | |
| Thermoplastic | Desmomelt | 3.4 | 3.4 | 3.4 | 3.4 | 1.7 | 1.7 |
| Polyurethane | 540/1 | | | | | | |
| Resin | | | | | | | |
| Thermoplastic | PKHH | 5.0 | 5.0 | 5.0 | 5.0 | 2.5 | 2.5 |
| Phenoxy Resin | | | | | | | |
| Acrylate Resin | Ebecryl-8413 | — | — | — | — | 2.9 | 2.9 |
| Acrylate Resin | Ebecryl-1300 | — | — | — | — | 2.9 | 2.9 |
| Curing Catalyst | Omnirad-73 | — | — | — | — | — | 0.6 |
| for | | | | | | | |
| Acrylate Resin | | | | | | | |
| (UV Catalyst) | | | | | | | |
| Curing Catalyst | Luperex DI | — | — | — | — | 0.6 | — |
| for | | | | | | | |
| Acrylate Resin | | | | | | | |
| (Thermal | | | | | | | |
| Catalyst) | | | | | | | |
| Functional | Functional | 5.6 | 5.6 | 5.6 | 5.6 | 2.8 | 2.8 |
| Additives | Additives | | | | | | |
| Glycol Ether | Eastman DE | 2.8 | 2.8 | 2.8 | 2.8 | 2.8 | 2.8 |
| Acetate | Acetate | | | | | | |
| Glycol Ether | Propylene | 4.2 | 4.2 | 4.2 | 4.2 | 4.2 | 4.2 |
| Acetate | glycol | | | | | | |
| | monomethyl | | | | | | |
| | ether acetate | | | | | | |
| Glycol Ether | Downol PPH | 2.8 | 2.8 | 2.8 | 2.8 | 2.8 | 2.8 |
| Glycol Ether | Eastman DB | 19.6 | 19.6 | 19.6 | 19.6 | 19.6 | 19.6 |
| | Solvent | | | | | | |
| Conductive | Ag Flake 1 | — | 16.2 | 37.7 | 8.1 | 56.0 | 56.0 |
| Filler | | | | | | | |
| Conductive | Ag Flake 2 | 45.8 | 37.7 | 16.2 | 45.8 | — | — |
| Filler | | | | | | | |
| Conductive | Ag Flake 4 | 8.1 | — | — | — | — | — |
| Filler | | | | | | | |

| | | | | | | |
|---|---|---|---|---|---|---|
| Total | 100.0 | 100.0 | 100.0 | 100.0 | 100.0 | 100.0 |

TABLE 5
Chemical composition of Example 17 to Example 21.

| | | Ex- | Ex- | Ex- | Ex- | Ex- |
|---|---|---|---|---|---|---|
| Category of | | ample | ample | ample | ample | ample |
| Raw Materials | Chemical Name | 17 | 18 | 19 | 20 | 21 |
| Cross-linker | Maprenel | 1.4 | 1.4 | 1.2 | 1.4 | 1.4 |
| | MF650 (55% in | | | | | |
| | isobutanol) | | | | | |
| Cross-linker | Vestanat B | — | — | 2.0 | — | — |
| (blocked | 1358A | | | | | |
| isocyanate) | | | | | | |
| Thermoplastic | Dynapol L-411 | 1.4 | 1.4 | 1.2 | 1.4 | 1.4 |
| Polyester Resin | | | | | | |
| Thermoplastic | Desmomelt 540/1 | 3.4 | 3.4 | 3.0 | 3.5 | 3.5 |
| Polyurethane | | | | | | |
| Resin | | | | | | |
| Thermoplastic | PKHH | 2.5 | 2.5 | 4.4 | 5.1 | 5.1 |
| Phenoxy Resin | | | | | | |
| Epoxy Resin | EPON 1001F | 2.5 | 2.5 | — | — | — |
| | (Hexion) | | | | | |
| Curing Catalyst | 2E4MZ-CN | 0.3 | — | — | — | — |
| for Epoxy | | | | | | |
| Resisn | | | | | | |
| Curing | Diphenylio- | — | 0.3 | — | — | — |
| Catalyst for | donium | | | | | |
| Epoxy Resin | hexafluoro- | | | | | |
| (UV Catalyst) | phosphate | | | | | |
| Functional | Functional | 5.7 | 5.7 | 4.9 | 5.7 | 5.7 |
| Additives | Additives | | | | | |
| Glycol Ether | Eastman DE | 2.8 | 2.8 | 2.5 | 23.0 | 23.0 |
| Acetate | Acetate | | | | | |
| Glycol Ether | Propylene glycol | 4.2 | 4.2 | 3.7 | — | — |
| Acetate | monomethyl | | | | | |
| | ether acetate | | | | | |
| Glycol Ether | Downol PPH | 2.8 | 2.8 | 2.5 | — | — |
| Glycol Ether | Eastman DB | 19.4 | 19.4 | 17.3 | 5.4 | 5.4 |
| | Solvent | | | | | |
| Conductive | Ag Flake 1 | 53.9 | 53.9 | 57.2 | — | — |
| Filler | | | | | | |
| Conductive | Silver Coated | — | — | — | 54.6 | — |
| Filler | Copper Flake | | | | | |
| Conductive | Silver Coated | — | — | — | — | 54.6 |
| Filler | Brass Flake | | | | | |

| | | | | | |
|---|---|---|---|---|---|
| Total | 100.0 | 100.0 | 100.0 | 100.0 | 100.0 |

TABLE 6
Chemical composition of Example 22 to Example 26.

| | | Ex- | Ex- | Ex- | Ex- | Ex- |
|---|---|---|---|---|---|---|
| Category of | Chemical | ample | ample | ample | ample | ample |
| Raw Materials | Name | 22 | 23 | 24 | 25 | 26 |
| Cross-linker | Maprenel | 1.7 | 1.7 | 1.3 | 1.4 | 1.4 |
| | MF650 (55% | | | | | |
| | in isobutanol) | | | | | |
| Thermoplastic | Dynapol L-411 | 1.7 | 1.7 | 1.3 | 1.4 | 1.4 |
| Polyester Resin | | | | | | |
| Thermoplastic | Desmomelt | 4.2 | 4.2 | 3.8 | 3.5 | 3.5 |
| Polyurethane | 540/1 | | | | | |
| Resin | | | | | | |
| Thermoplastic | PKHH | 6.2 | 6.2 | 4.7 | 5.1 | 5.1 |
| Phenoxy Resin | | | | | | |
| Functional | Functional | 3.4 | 3.4 | 2.6 | 5.7 | 5.7 |
| Additives | Additives | | | | | |
| Glycol Ether | Eastman DE | 43.2 | 43.2 | 21.2 | 23.0 | 23.0 |
| Acetate | Acetate | | | | | |
| Glycol Ether | Eastman DB | — | — | — | 5.4 | 5.4 |
| | Solvent | | | | | |
| Ester | Dibasic Ester | — | — | 1.7 | — | — |
| | (DBE) | | | | | |
| Ketone | C11-Ketone | 20.5 | 20.5 | 10.1 | — | — |
| Conductive Filler | Ag Flake 1 | — | — | 53.2 | 51.9 | 46.5 |
| Conductive Filler | Graphite Flake | 16.8 | — | — | — | — |
| Conductive Filler | Graphene | — | 16.8 | 0.1 | — | — |
| | Powder | | | | | |
| Conductive Filler | Carbon Black | 2.3 | 2.3 | — | — | — |
| Conductive Filler | Ag MoC (Silver | — | — | — | — | 2.7 |
| | neodecanoate) | | | | | |
| Conductive Filler | Nano Silver | — | — | — | — | 8.2 |

| | | | | | |
|---|---|---|---|---|---|
| Total | 100.0 | 100.0 | 100.0 | 100.0 | 100.0 |

### Examples Non-Conductive Inks and Compositions

Several compositions were prepared by dissolving mixture of thermoplastic polyester resins, polyurethane resins and phenoxy resins having hydroxyl functional groups in mixture of different category of solvents at 70-100° C. The reaction mixtures were cooled to room temperature followed by addition of functional additive package, containing surfactants, rheology modifier, dispersants, defoaming agents and wetting agents. Reactive cross-linkers and/or other acrylics or epoxy curing agents were then mixed well with the above polymer resin mixtures. The compositions were further mixed with several different conductive particles for the preparation of conductive inks, coatings and adhesive compositions. The conductive particles were mixed using an orbital mixer (1000 rpm for 1 min for 3 cycles). Certain compositions were also milled in a three-roll mill for a few minutes to obtain to obtain a homogeneous paste.

Example 27 to Example 36 and Example 41 to Example 61 below are conductive compositions prepared without a thermosetting resin. Example 37 to Example 40 are conductive compositions prepared using a thermosetting resin and corresponding curing catalyst.

### Example 27

| Raw Material Category | Chemical Name | Weight % |
|---|---|---|
| Cross-linker | Maprenel MF650 | 2.1 |
| | (55% in isobutanol) | |
| Thermoplastic | Dynapol L-411 | 2.1 |
| Polyester Resin | | |
| Thermoplastic | Desmomelt 540/1 | 5.2 |
| Polyurethane Resin | | |
| Thermoplastic | PKHH | 7.7 |
| Phenoxy Resin | | |
| Functional Additives | Functional Additives | 3.9 |
| Glycol Acetate | Eastman DE Acetate | 34.2 |
| Glycol Ether | Downol PPH | 7.3 |
| Glycol Acetate | Propylene glycol | 7.3 |
| | monomethyl ether | |
| | acetate | |
| Non-conductive Filler | Talc Powder | 28.3 |
| Non-conductive Filler | Ceraflour 920 | 1.8 |
| Total | | 100.0 |

30.1 weight % of mixture talc and organic filler and 69.9 weight % of polymer solution of was mixed together using an orbital mixer at 1000 rpm for 1 min for 3 cycles to obtain a homogeneous paste. The viscosity of the paste was found to be in the range of 11000-15000 cP and is suitable for the screen printing.

### Examples 28 to 61

Compositions having the components specified in Tables 7-11 below were prepared as per the process described in Example 27 above.

TABLE 7
Chemical composition of Example 27 to Example 34.

| | | Ex- | Ex- | Ex- | Ex- | Ex- | Ex- | Ex- | Ex- |
|---|---|---|---|---|---|---|---|---|---|
| Category of | Chemical | ample- | ample- | ample- | ample- | ample- | ample- | ample- | ample- |
| Raw Materials | Name | 27 | 28 | 29 | 30 | 31 | 32 | 33 | 34 |
| Cross-linker | Maprenel | 2.1 | 2.2 | 2.2 | 2.2 | 3.1 | 3.2 | 2.2 | 3.2 |
| | MF650 | | | | | | | | |
| | (55% in | | | | | | | | |
| | isobutanol) | | | | | | | | |
| Thermoplastic | Dynapol | 2.1 | 2.2 | 2.2 | 2.2 | 3.1 | 3.2 | 2.2 | 3.2 |
| Polyester Resin | L-411 | | | | | | | | |
| Thermoplastic | Desmomelt | 5.2 | 5.5 | 5.5 | 5.5 | 7.8 | 8.1 | 5.6 | 8.1 |
| Polyurethane | 540/1 | | | | | | | | |
| Resin | | | | | | | | | |
| Thermoplastic | PKHH | 7.7 | 8.0 | 8.0 | 8.0 | 11.4 | 11.8 | 8.1 | 11.8 |
| Phenoxy Resin | | | | | | | | | |
| Functional | Functional | 3.9 | 4.1 | 4.1 | 4.1 | 5.8 | 1.5 | 1.4 | 2.0 |
| Additives | Additives | | | | | | | | |
| Glycol Ether | Eastman DE | 34.2 | — | — | — | 39.6 | 32.8 | 26.1 | 33.3 |
| Acetate | Acetate | | | | | | | | |
| Glycol Ether | Butyl Carbitol | — | 5.1 | 5.1 | 5.1 | — | — | — | — |
| Acetate | Acetate | | | | | | | | |
| Glycol Ether | Propylene glycol | 7.3 | 10.2 | 10.2 | 5.1 | — | — | — | — |
| Acetate | monomethyl | | | | | | | | |
| | ether acetate | | | | | | | | |
| Ketone | C11-Ketone | — | — | — | — | 17.0 | 15.6 | 12.5 | 15.9 |
| Glycol Ether | Downol PPH | 7.3 | — | — | — | — | — | — | — |
| Glycol Ether | Butyl Carbitol | — | — | 35.5 | 5.1 | — | — | 10.6 | — |
| Glycol Ether | Propylene glycol | — | — | — | — | — | — | 3.8 | 12.0 |
| | monomethyl ether | | | | | | | | |
| Hydrocarbon | Aromatic 150 | — | — | — | — | — | 13.3 | — | — |
| | Fluids | | | | | | | | |
| Alcohol | Terpineol | — | 35.5 | — | 35.5 | | | — | — |
| Non-conductive | Talc | 28.3 | 26.8 | 26.8 | 26.8 | 11.6 | 10.4 | 27.6 | 10.4 |
| Filler | | | | | | | | | |
| Non-conductive | Ceraflour 920 | 1.8 | 0.5 | 0.5 | 0.5 | 0.6 | — | — | — |
| Filler | | | | | | | | | |

| | | | | | | | | |
|---|---|---|---|---|---|---|---|---|
| Total | 100.0 | 100.0 | 100.0 | 100.0 | 100.0 | 100.0 | 100.0 | 100.0 |

TABLE 8
Chemical composition of Example 35 to Example 40.

| | | Ex- | Ex- | Ex- | Ex- | Ex- | Ex- |
|---|---|---|---|---|---|---|---|
| Category of | Chemical | ample- | ample- | ample- | ample- | ample- | ample- |
| Raw Materials | Name | 35 | 36 | 37 | 38 | 39 | 40 |
| Cross-linker | Maprenel | 2.5 | 2.7 | 1.9 | 1.9 | 2.5 | 2.5 |
| | MF650 (55% | | | | | | |
| | in isobutanol) | | | | | | |
| Thermoplastic | Dynapol | 2.5 | 2.7 | 1.9 | 1.9 | 2.5 | 2.5 |
| Polyester Resin | L-411 | | | | | | |
| Thermoplastic | CAB 381-2 | — | 2.7 | — | — | — | — |
| Polyester Resin | | | | | | | |
| Thermoplastic | Desmomelt | 6.2 | 6.7 | 4.8 | 4.8 | 6.1 | 6.1 |
| Polyurethane | 540/1 | | | | | | |
| Resin | | | | | | | |
| Thermoplastic | PKHH | 9.0 | 7.4 | 7.1 | 7.1 | 4.5 | 4.5 |
| Phenoxy Resin | | | | | | | |
| Epoxy Resin | EPON 1001F | — | — | — | — | 4.5 | 4.5 |
| | (Hexion) | | | | | | |
| | (Bisphenol | | | | | | |
| | A based) | | | | | | |
| Acrylate Resin | Ebecryl 8413 | — | — | 9.8 | 9.8 | — | — |
| Acrylate Resin | Ebecryl 1300 | — | — | 9.8 | 9.8 | — | — |
| Curing Catalyst | 2E4MZ-CN | — | — | — | — | 0.4 | — |
| for Epoxy Resin | | | | | | | |
| Curing Catalyst | Diphenyl- | — | — | — | — | — | 0.4 |
| for Epoxy Resin | iodonium | | | | | | |
| (UV Catalyst) | hexafluoro- | | | | | | |
| | phosphate | | | | | | |
| Curing Catalyst | ACHN | — | — | 2.0 | — | — | — |
| for Acrylate | | | | | | | |
| Resin | | | | | | | |
| Curing Catalyst | Omnirad- | — | — | — | 2.0 | — | — |
| for Acrylate | 1173 | | | | | | |
| Resin | | | | | | | |
| Functional | Functional | 10.1 | 9.0 | 7.9 | 7.9 | 10.0 | 10.0 |
| Additives | Additives | | | | | | |
| Glycol Ether | Butyl Carbitol | | 4.9 | | | | |
| Acetate | Acetate | | | | | | |
| Glycol Ether | Propylene | 15.2 | | 11.9 | 11.9 | 15.1 | 15.1 |
| Acetate | glycol | | | | | | |
| | monomethyl | | | | | | |
| | ether acetate | | | | | | |
| Ketone | C11-Ketone | — | 4.9 | — | — | — | — |
| Glycol Ether | Butyl Carbitol | 35.5 | | 27.8 | 27.8 | 35.2 | 35.2 |
| Hydrocarbon | Aromatic | — | 4.8 | — | — | — | — |
| | 150 Fluids | | | | | | |
| Alcohol | Terpineol | — | 33.9 | — | — | — | — |
| Non-conductive | Talc | 19.0 | 19.9 | 14.9 | 14.9 | 19.3 | 19.3 |
| Filler | | | | | | | |
| Non-conductive | Ceraflour 920 | — | 0.6 | — | — | — | — |
| Filler | | | | | | | |

| | | | | | | |
|---|---|---|---|---|---|---|
| Total | 100.0 | 100.0 | 100.0 | 100.0 | 100.0 | 100.0 |

TABLE 9
Chemical composition of Example 41 to Example 48.

| Category | | Ex- | Ex- | Ex- | Ex- | Ex- | Ex- | Ex- | Ex- |
|---|---|---|---|---|---|---|---|---|---|
| of Raw | Chemical | ample- | ample- | ample- | ample- | ample- | ample- | ample- | am [symbol] |
| Materials | Name | 41 | 42 | 43 | 44 | 45 | 46 | 47 | 48 |
| Cross-linker | Maprenel | 2.3 | 2.4 | 3.4 | 3.4 | 3.4 | 2.5 | 2.9 | 3.2 |
| | MF650 (55% | | | | | | | | |
| | in isobutanol) | | | | | | | | |
| Curing | Vestanat B | 3.8 | — | — | — | — | — | — | — |
| Catalyst for | 1358A from | | | | | | | | |
| polyol | Evonik | | | | | | | | |
| Thermoplastic | Dynapol | 2.3 | 2.4 | 3.4 | 3.4 | 3.4 | 2.5 | 2.9 | 3.2 |
| Polyester | L-411 | | | | | | | | |
| Resin | | | | | | | | | |
| Thermoplastic | Desmomelt | 5.7 | 5.9 | 8.4 | 8.4 | 8.4 | 6.2 | 7.3 | 7.9 |
| Polyurethane | 540/1 | | | | | | | | |
| Resin | | | | | | | | | |
| Thermoplastic | PKHH | 8.4 | 8.6 | 12.4 | 12.4 | 12.4 | 9.0 | 10.6 | 11.7 |
| Phenoxy | | | | | | | | | |
| Resin | | | | | | | | | |
| Functional | Functional | 9.4 | 9.6 | 6.8 | 6.8 | 6.8 | 10.1 | 11.9 | 6.5 |
| Additives | Additives | | | | | | | | |
| Glycol Ether | Eastman DE | — | — | 41.2 | 41.2 | 41.2 | — | — | 38.8 |
| Acetate | Acetate | | | | | | | | |
| Glycol Ether | Propylene | 14.1 | 14.5 | — | — | — | 15.2 | 17.9 | — |
| Acetate | glycol | | | | | | | | |
| | monomethyl | | | | | | | | |
| | ether acetate | | | | | | | | |
| Ketone | C11-Ketone | — | — | 19.5 | 19.5 | 19.5 | — | — | 18.4 |
| Glycol Ether | Butyl Carbitol | 32.9 | 33.7 | — | — | — | 35.5 | 41.7 | |
| Non- | Talc | 21.1 | 23.1 | — | — | — | | 4.8 | 10.4 |
| conductive | | | | | | | | | |
| Filler | | | | | | | | | |
| Non- | Silica | — | — | — | — | — | 19.0 | — | — |
| conductive | | | | | | | | | |
| Filler | | | | | | | | | |
| Non- | Ceraflour 991 | — | — | — | — | 5.0 | — | — | — |
| conductive | | | | | | | | | |
| Filler | | | | | | | | | |
| Non- | Ceraflour 929 | — | — | — | 5.0 | — | — | — | — |
| conductive | | | | | | | | | |
| Filler | | | | | | | | | |
| Non- | Ceraflour 920 | — | — | 5.0 | | — | — | — | — |
| conductive | | | | | | | | | |
| Filler | | | | | | | | | |

| | | | | | | | | |
|---|---|---|---|---|---|---|---|---|
| Total | 100.0 | 100.0 | 100.0 | 100.0 | 100.0 | 100.0 | 100.0 | 100.0 |

[symbol]

indicates data missing or illegible when filed

TABLE 10
Chemical composition of Example 49 to Example 55.

| | | Ex- | Ex- | Ex- | Ex- | Ex- | Ex- | Ex- |
|---|---|---|---|---|---|---|---|---|
| Category of | Chemical | ample- | ample- | ample- | ample- | ample- | ample- | ample- |
| Raw Materials | Name | 49 | 50 | 51 | 52 | 53 | 54 | 55 |
| Cross-linker | Maprenel | 3.2 | 2.1 | 3.1 | 3.2 | 2.2 | 2.2 | 2.1 |
| | MF650 (55% | | | | | | | |
| | in isobutanol) | | | | | | | |
| Thermoplastic | Dynapol | 3.2 | 2.1 | 3.1 | 3.2 | 2.2 | 2.2 | 2.1 |
| Polyester Resin | L-411 | | | | | | | |
| Thermoplastic | Desmomelt | 8.1 | 5.1 | 7.6 | 8.0 | 5.4 | 5.4 | 5.1 |
| Polyurethane | 540/1 | | | | | | | |
| Resin | | | | | | | | |
| Thermoplastic | PKHH | 11.8 | 7.4 | 11.1 | 11.7 | 7.9 | 7.8 | 7.5 |
| Phenoxy Resin | | | | | | | | |
| Functional | Functional | 1.5 | 2.6 | 12.5 | 2.3 | 2.8 | 2.8 | 2.6 |
| Additives | Additives | | | | | | | |
| Glycol Ether | Eastman DE | 41.7 | — | — | 41.4 | — | — | — |
| Acetate | Acetate | | | | | | | |
| Glycol Ether | Dipropylene | — | 8.5 | — | — | 8.0 | 8.1 | 8.6 |
| | Glycol | | | | | | | |
| Acetate | Methyl Ether | | | | | | | |
| | Acetate | | | | | | | |
| Glycol Ether | Propylene | — | 0.0 | 18.8 | — | — | — | — |
| Acetate | glycol | | | | | | | |
| | monomethyl | | | | | | | |
| | ether acetate | | | | | | | |
| Ketone | C11-Ketone | 19.9 | — | — | 19.7 | — | — | — |
| Glycol Ether | Dipropylene | — | 17.1 | — | — | 15.9 | 16.2 | 17.2 |
| | Glycol | | | | | | | |
| | Methyl Ether | | | | | | | |
| Glycol Ether | Butyl Carbitol | — | 17.1 | 43.8 | 0.0 | 15.9 | 16.2 | 17.2 |
| Non-conductive | Talc | 10.4 | 1.1 | — | 10.4 | — | — | 1.1 |
| Filler | | | | | | | | |
| Non-conductive | Titanium | — | 36.1 | — | 0.0 | 39.6 | 39.3 | 36.4 |
| Filler | Dioxide | | | | | | | |
| Non-conductive | Silica | — | 0.8 | — | — | — | — | — |
| Filler | | | | | | | | |

| | | | | | | | |
|---|---|---|---|---|---|---|---|
| Total | 100.0 | 100.0 | 100.0 | 100.0 | 100.0 | 100.0 | 100.0 |

TABLE 11
Chemical composition of Example 56 to Example 61.

| | | Ex- | Ex- | Ex- | Ex- | Ex- | Ex- |
|---|---|---|---|---|---|---|---|
| Category of | Chemical | ample- | ample- | ample- | ample- | ample- | ample- |
| Raw Materials | Name | 56 | 57 | 58 | 59 | 60 | 61 |
| Cross-linker | Maprenel | 2.1 | 2.3 | 2.2 | 2.5 | 2.1 | 2.1 |
| | MF650 | | | | | | |
| | (55% in | | | | | | |
| | isobutanol) | | | | | | |
| Thermoplastic | Dynapol | 2.1 | 2.3 | 2.2 | 2.5 | 2.1 | 2.1 |
| Polyester Resin | L-411 | | | | | | |
| Thermoplastic | Desmomelt | 5.1 | 5.7 | 5.4 | 6.2 | 5.2 | 5.1 |
| Polyurethane | 540/1 | | | | | | |
| Resin | | | | | | | |
| Thermoplastic | PKHH | 7.5 | 8.3 | 7.8 | 9.0 | 7.6 | 7.5 |
| Phenoxy Resin | | | | | | | |
| Functional | Functional | 2.6 | 3.0 | 2.8 | 10.5 | 2.7 | 2.6 |
| Additives | Additives | | | | | | |
| Glycol Ether | Eastman DE | — | — | — | 4.8 | — | — |
| Acetate | Acetate | | | | | | |
| Glycol Ether | Dipropylene | 8.6 | 25.5 | 8.1 | — | 8.3 | 8.6 |
| Acetate | Glycol | | | | | | |
| | Methyl | | | | | | |
| | Ether Acetate | | | | | | |
| Glycol Ether | Propylene | — | — | — | 14.8 | — | — |
| Acetate | glycol | | | | | | |
| | monomethyl | | | | | | |
| | ether acetate | | | | | | |
| Glycol Ether | Dipropylene | 17.1 | — | 16.2 | — | 16.5 | 17.2 |
| | Glycol | | | | | | |
| | Methyl Ether | | | | | | |
| Glycol Ether | Butyl | 17.1 | 28.1 | 16.2 | 30.5 | 16.5 | 17.2 |
| | Carbitol | | | | | | |
| Non-conductive | Talc | 1.1 | — | — | 19.2 | 1.2 | 1.1 |
| Filler | | | | | | | |
| Non-conductive | Titanium | 36.2 | — | 39.3 | — | 37.1 | |
| Filler | Dioxide | | | | | | |
| Non-conductive | BN | — | — | — | — | — | 36.4 |
| Filler | | | | | | | |
| Non-conductive | Barium | — | 24.8 | — | — | — | — |
| Filler | Titanate | | | | | | |
| Non-conductive | Fumed | 0.5 | | — | — | — | — |
| Filler | Silica | | | | | | |
| Non-conductive | Ceraflour | — | — | — | — | 0.7 | — |
| Filler | 991 | | | | | | |

| | | | | | | |
|---|---|---|---|---|---|---|
| Total | 100.0 | 100.0 | 100.0 | 100.0 | 100.0 | 100.0 |

### Thermoforming and Injection Molding Performances: Construction of 3D Electronics:

Conductive and Dielectric compositions disclosed above are characterized thoroughly and tested for screen printing, electrical performances, compatibility among different inks and substrates (PC and PET), tested for adhesion and stability under different accelerated environmental testing conditions. These inks further tested for thermal stability, thermoforming, and injection molding stability.

For example, Table 12 below summarizes various characteristics and testing performance attributes of conducting compositions as described in Example 1 to Example 26.

TABLE 12
Characterization and testing performance testing results
of various conducting compositions (Example 1 to Example 26)

| | | | | Surface | | | | |
|---|---|---|---|---|---|---|---|---|
| | | | | Resis- | | | | |
| | | | | tance; | Change of Resistance after | | | |
| | Viscosity | | | Before | Thermoforming as per ‘Cone | | | |
| | @ 5 | | Ad- | Thermo- | Formability Test Procedure’ | | | Injection |
| | rpm, cP | Solid | hesion | forming | for 1000 μm line width of PC | | | Molding |
| | (Cone | content, | (PC/ | (mΩ/ | @30% | @37% | @46% | Wash out |
| Examples | and Plate) | (Wt %) | PET) | Sq/mil) | Strain | Strain | Strain | Stability |
| Example 1 | 4000-7000 | 62-68 | 5B | 40-45 | 2 | 3 | 6 | Good |
| Example 2 | 9000-13000 | 62-68 | 5B | 40-45 | 3 | 3 | 5 | Good |
| Example 3 | 8000-12000 | 62-68 | 5B | 30-35 | 2 | 3 | 7 | NM |
| Example 4 | 5000-8000 | 60-64 | 5B | 20-25 | 2 | 3 | 4 | NM |
| Example 5 | 8000-11000 | 62-68 | 5B | 40-45 | 1 | 2 | 3 | NM |
| Example 6 | 40000-60000 | 62-68 | NM | NM | NM | NM | NM | NM |
| Example 7 | 45000-55000 | 70-74 | 5B | 40-50 | 1 | 2 | 3 | NM |
| Example 8 | 9000-12000 | 62-68 | 5B | 30-35 | 2 | 2 | 3 | NM |
| Example 9 | 13000-17000 | 62-68 | 5B | 30-35 | 2 | 3 | 3 | NM |
| Example 10 | 8000-12000 | 62-68 | 5B | 30-35 | 1.5 | 2 | 3 | Excellent |
| Example 11 | 13000-16000 | 62-68 | 5B | 20-25 | 1 | 2 | 3 | Excellent |
| Example 12 | 8000-12000 | 62-68 | 5B | 20-25 | 2 | 3 | 4 | NM |
| Example 13 | 8000-12000 | 62-68 | 5B | 20-25 | 2 | 3 | 5 | NM |
| Example 14 | 8000-12000 | 62-68 | 5B | 20-25 | 2 | 3 | | NM |
| Example 15 | 13000-17000 | 62-68 | NM | NM | NM | NM | NM | NM |
| Example 16 | 10000-15000 | 62-68 | NM | NM | NM | NM | NN | NM |
| Example 17 | 3000-5000 | 62-68 | 5B | 30-35 | 2 | 3 | 5 | NM |
| Example 18 | 13000-17000 | 62-68 | NM | NM | NM | NM | NM | NM |
| Example 19 | 15000-20000 | 62-68 | NM | NM | NM | NM | NM | NM |
| Example 20 | 8000-12000 | 62-68 | NM | NM | NM | NM | NM | NM |
| Example 21 | 8000-12000 | 62-68 | NM | NM | NM | NM | NM | NM |
| Example 22 | 7000-11000 | 30-40 | NN | 26000 | 22 | NM | NM | NM |
| Example 23 | 7000-11000 | 30-40 | NM | 22000 | 20 | NM | NM | NM |
| Example 24 | 6000-10000 | 62-68 | 5B | 45 | 1.5 | 2.5 | 4 | NM |
| Example 25 | 15000-20000 | 50-65 | NM | NM | NM | NM | NM | NM |
| Example 26 | 20000-25000 | 50-65 | NM | NM | NM | NM | NM | NM |

Further, Table 13 below summarizes various characteristics and testing performance attributes of non-conducting compositions as described in Example 27 to Example 61.

TABLE 13
Characterization and testing performance testing results of various
non-conducting compositions (Example 27 to Example 61)

| | | | | Injection |
|---|---|---|---|---|
| | Viscosity @ | | | Molding |
| Examples | 5 rpm, cP | Solid | Adhesion | Wash out |
| Number | (Cone and Plate) | content, % | (PC/PET) | Stability |
| Example 27 | 11000-15000 | 45-50% | 3B-4B | NA |
| Example 28 | 16000-20000 | 45-50% | 3B | NA |
| Example 29 | 14000-17000 | 45-50% | 4B | NA |
| Example 30 | 16000-20000 | 45-50% | 4B | NA |
| Example 31 | 14000-17000 | 35-40% | 4B | NA |
| Example 32 | 16000-20000 | 35-40% | 5B | Excellent |
| Example 33 | 16000-20000 | 45-50% | 5B | Excellent |
| Example 34 | 11000-14000 | 35-40% | 5B | Excellent |
| Example 35 | 11000-15000 | 35-40% | 5B | Excellent |
| Example 36 | 14000-17000 | 43-48% | 3B | NA |
| Example 37 | 11000-14000 | 45-50% | 4B | NM |
| Example 38 | 11000-14000 | 45-50% | 4B | NM |
| Example 39 | 10000-14000 | 45-50% | NM | NM |
| Example 40 | 10000-14000 | 45-50% | NM | NM |
| Example 41 | 9000-14000 | 45-50% | NM | NM |
| Example 42 | 11000-14000 | 45-50% | 5B | Excellent |
| Example 43 | 16000-19000 | 30-35% | NM | NA |
| Example 44 | 11000-14000 | 30-35% | 4B | NA |
| Example 45 | 11000-14000 | 30-35% | NM | NA |
| Example 46 | 10000-14000 | 45-50% | NM | NM |
| Example 47 | 10000-16000 | 35-45% | 5B | NA |
| Example 48 | 12000-18000 | 35-40% | NM | NA |
| Example 49 | 14000-17000 | 35-40% | NM | NA |
| Example 50 | 9000-14000 | 55-58% | 5B | NA |
| Example 51 | 4000-7000 | 23-28% | 5B | NA |
| Example 52 | 16000-19000 | 35-40% | 5B | NA |
| Example 53 | 40000-44000 | 57-62% | 5B | NA |
| Example 54 | 36000-41000 | 57-62% | 5B | NA |
| Example 55 | 25000-30000 | 57-62% | 5B | NA |
| Example 56 | 25000-30000 | 57-62% | 5B | NA |
| Example 57 | 70000-130000 | 57-62% | 5B | NA |
| Example 58 | 50000-70000 | 57-62% | 5B | NA |
| Example 59 | 8000-14000 | 38-42% | 5B | Excellent |
| Example 60 | 15000-18000 | 55-59% | 5B | NA |
| Example 61 | 20000-27000 | 57-62% | NM | NA |

Intercompatibility of conductive and nonconductive materials along with compatibility with different flexible polymer substrates, decorative inks, adhesives, encapsulants and injection molding resins are important aspects for the manufacturing of IME and similar structures.

Compatibility of Wet Silver Ink Compositions with Various PC Substrates

The wet silver ink compositions are highly compatible with various PC substrates. The compatibility of wet silver inks (Example 1, 17, 23 and 25) with PC film substrates (Makrafol DE1.4) was investigated, with microscopic images of screen printed patterns (1000 μm line) of wet silver inks being captured at different time intervals (immediately, i.e., 0 min, 1, 2, 3, 5 and 15 min) before drying using a jet dryer. These results depict very good compatibility of silver inks with PC substrates.

Inter-Compatibility of Silver Ink and Dielectric Ink Compositions, and Compatibility with Various Nascent and Graphic Coated PET and PC Substrates

The disclosed silver ink and dielectric ink compositions are highly intercompatible and compatible with various nascent and graphic coated PET and PC substrates.

Adhesion tests (tested as per ASTM F1842-09) to demonstrate the compatibility of dried Silver and Dielectric Inks with various polymer film substrates (PC, PET and graphic coated PC film substrates) were carried out. Table 14 below summarizes the representative adhesion test results of silver ink (Example 2) and dielectric ink (Example 33 and 34) on various nascent PET (MacDermid Autotype AHU5, CT5 and HT5), nascent PC (Makrafol DE1.4) and graphic ink printed on PC (MacDermid Autotype XFG2502L-HTR952) film substrates. Table 4 also summarizes representative adhesion test results of silver ink (Example 2) on dielectric ink (Example 33 and 34) coated on various nascent PET (MacDermid Autotype AhU5, CT5 and HT5), nascent PC (Makrafol DE1.4) and graphic ink printed on PC (MacDermid Autotype XFG2502L-HTR952) film substrates.

TABLE 14

| | | Silver | Dielectric | Dielectric |
|---|---|---|---|---|
| Substrate | Substrate | Ink | Ink | Ink |
| Type | Coating | Example 2 | Example 34 | Example 33 |
| PET (AHU5) | Nascent | 5B | 5B | 5B |
| | Example 33 | 5B | — | — |
| | Example 34 | 5B | — | — |
| PET (HT5) | Nascent | 5B | 5B | 56 |
| | Example 33 | 5B | — | — |
| | Example 34 | 5B | — | — |
| PET (CT5) | Nascent | 58 | 58 | 5B |
| | Example 33 | 5B | — | — |
| | Example 34 | 5B | — | — |
| PC (Makrafol | Nascent | 56 | 58 | 5B |
| DE1.4) | Example 33 | 58 | — | — |
| | Example 34 | 5B | — | — |
| Graphic Printed | Nascent | 5B | 5B | 5B |
| PC (XFG2502L- | Example 33 | 5B | — | — |
| HTR952) | Example 34 | 5B | — | — |

Adhesion tests were also carried out on the following:
silver Ink (Example 1) printed on nascent PC (Makrafol DE1.4),
silver ink (Example 1) printed on dielectric Ink (Example 32) coated on nascent PC (Makrafol DE1.4),
silver ink (Example 1) printed on graphic ink printed PC (MacDermid Autotype XFG2502L-HTR952),
silver ink (Example 1) printed on dielectric Ink (Example 32) coated on graphic ink printed PC (MacDermid Autotype XFG2502L-HTR952),
dielectric Ink (Example 32) on nascent PC (Makrafol DE1.4), graphic ink (Example 32) printed on PC (MacDermid Autotype XFG2502L-HTR952),
multilayer stack of silver ink (Example 10)/dielectric ink (Example 53)/silver ink (Example 10) on nascent PC (Makrafol DE1.4),
multilayer stack of silver ink (Example 10)/dielectric ink (Example 54)/silver ink (Example 10) on nascent PC (Makrafol DE1.4).

All these samples show 5B adhesion test results as per ASTM F1842-09.

### Accelerated Environmental Testing

The disclosed silver ink and dielectric ink compositions are highly robust and stable when tested at different accelerated environmental test conditions as per JEDEC 22-A101 (Environmental Testing, 85° C/85 RH) and IEC 60068-2-2 (Thermal Aging Test/Dry Heat Test). A typical test structure consisted of 500 μm lines of conducting silver circuit traces prepared by screen printing on nascent PC and drying by jet drying. Electrical resistances of these lines are measured before and after exposing to either 85° C/85 RH or 110° C. for 100-1000 h. Also, a stack of Dielectric Ink//Silver Ink//Dielectric Ink samples were also prepared and electrical resistances conducting silver circuit traces were measured. Further, adhesion of these inks was tested as per as per ASTM F1842-09 after exposing these samples to either 85° C./85 RH or 110° C. for 100 -1000 h.

Table 5 summarizes percentage of change of electrical resistance (% AR, calculated as per Equation 1) of the representative test structures prepared using Silver Ink (Example 10) and a stack of Dielectric Ink (Example 47)//Silver Ink (Example 10)//Dielectric Ink (Example 47) on nascent PC (Makrafol DE1.4) after exposing to 85° C/85 RH or 110° C. for 100h.

Percentage of change of electrical resistance (%JR)=[Resistance after−Resistance before/Resistance before] (Equation 1)

Adhesion testing of the above reliability test structures after exposure to environmental testing conditions were conducted as per ASTM F1842-09 and results are summarized in Table 15.

TABLE 15
Percentage of change of electrical resistance (% ΔR, calculated as per Equation 1) of
various representative test structures after exposing to 85° C./85 RH or 110° C. for 100 h.

| | | 85° C./85 RH for 100 h | | 110° C. for 100 h | |
|---|---|---|---|---|---|
| | Drying | | Adhesion | | Adhesion |
| Test Structure | Condition | (% ΔR) | Results | (% ΔR) | Results |
| A test pattern | 120° C. for | −6.1 | 5B | −6.7 | 5B |
| consists of 500 μm | 6 min. | | | | |
| lines of Silver | 120° C. for | −3.4 | 5B | −6.1 | 5B |
| Ink (Example 10) | 6 min followed | | | | |
| printed on nascent PC | by 80° C. | | | | |
| (Makrafol DE1.4). | stoving for 5 h. | | | | |
| A stack prepared | Silver Ink dried | −1.9 | 5B | −1.1 | 5B |
| on nascent PC | for 120° C. | | | | |
| substrate | for 6 min and two | | | | |
| (Makrafol DE1.4) | layers of | | | | |
| consist of: | Dielectric Ink | | | | |
| rectangle pattern | dried for | | | | |
| of Dielectric Ink | 120° C. 4 min | | | | |
| (Example 47, two- | (1^{st} layer) and 8 min | | | | |
| layers) // test | (2^{nd} layer). | | | | |
| traces of Silver Ink | Silver Ink dried | −0.6 | 5B | −0.2 | 5B |
| (Example 10, | for 120° C. for | | | | |
| 500 μm line width), | 6 min and | | | | |
| printed on the first | Dielectric Ink | | | | |
| Dielectric Ink | dried for | | | | |
| layer) // rectangle | 120° C. 4 min | | | | |
| pattern of | (1^{st} layer) and | | | | |
| Dielectric Ink | 8 min (2^{nd} | | | | |
| (Example 47, two- | layer). Overall | | | | |
| layers) to cover | stack stoved | | | | |
| the silver test | at 80° C. for | | | | |
| traces. | 5 h. | | | | |

Stack of Screen-Printed Silver Layer//Dielectric Layer//Graphic Layer coated Thermoformable PC Substrate

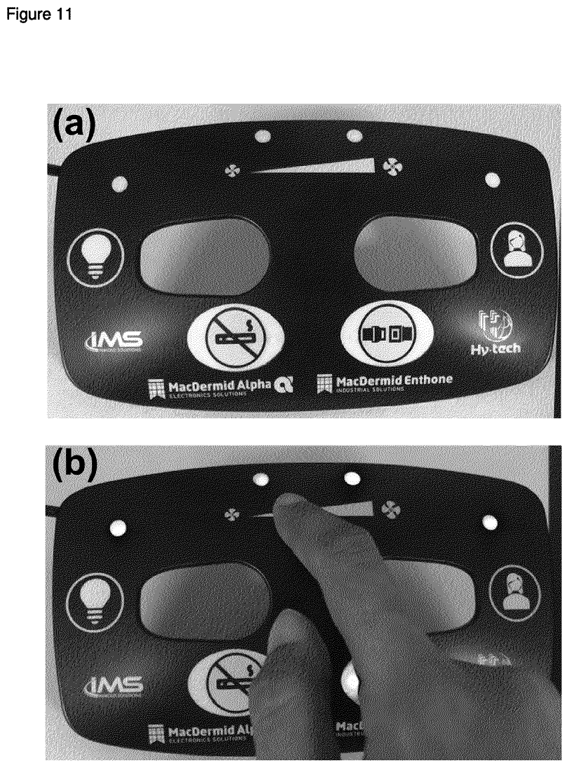

FIG. 2 shows a representative stack of screen-printed silver layer//dielectric layer//graphic layer coated thermoformable PC substrate (MacDermid Autotype Xtraform PC) (90) and an image sample prepared using Example 1 (silver ink) an Example 47 (dielectric ink) on a black graphic ink coated thermoformable PC substrate, which produced structures 110, 120 and 130 upon thermoforming. The interconnect lines printed in these structures are electrically connecting and do not show significant change of resistance after thermoforming. For the thermoforming process, screen printed samples as shown in FIG. 2, 100 as well as component mounted samples were expose to the temperature 170 ±2° C. for 30-35 seconds. The printed traces were faced to the heater during the thermoforming process. On exposure to heat, printed substrates get soften and placed over the forming tool under vacuum pressure of 4 Bar for 10-15 secs to get 3D thermoformed substrates as shown in FIGS. 2 as 110, 120 and 130. The images shown in FIGS. 2, 100, 110, 120 and 130 are correspond to Example 1. Similarly, Example 2, Example 4, Example 33, Example 34, Example 35 and Example 42 printed structures were also tested for thermoforming performances with different combinations on PC and PET substrates and found to be thermoformable.

One of the key attribute of the conductive and non-conductive compositions is the thermoformability. This is particularly important for IME and similar applications. To assess thermoformability of the 2D circuit traces, formed into 3D circuits/devices, a cone structure test vehicle was employed. To determine the thermoforming attribute of the traces an in-house developed procedure referred to as ‘Cone Formability Test Procedure’ was used. In this procedure, conductivity of a series of circuit traces is measure on a flat polymeric substrate. After forming, change in electrical resistance along with other failure mechanisms is used to assess the degree of thermoformability. This test structure has straight line traces with 150 μm, 300 μm, 500 μm and 1000 μm line widths. These flat line structures are thermoformed into a cylindrical conical shape that can be positive or negative. During thermoforming, various traces experience stretching that can vary from 0 to 58%. Key performance metric that determines thermoformability to be stretched without breaking or delaminating from the substrate and preferably with a low change in electrical resistance.

### Thermoforming Attribute of Silver Inks

Thermoforming attributes of silver inks were evaluated as per the ‘Cone Formability Test Procedure’ as described previously. In a typical process, silver ink was printed on a thermoformable polymer substrate (eg. PC or PET) and electrical resistances of the conducting test circuits were measured before and after thermoforming process to record the change of resistance at various % strain. FIG. 3a and FIG. 3b show representative images of a typical test sample of before and after thermoforming, respectively on a thermoformable PC substrate (Makrafol DE1.4). After forming, change in electrical resistance along with other failure mechanisms is used to assess the degree of thermoformability. For example, FIG. 3c and FIG. 3d, show the variation of electrical resistance of conducting Silver circuit traces of 1000 μm line width of Silver Inks (Example 1, Example 2, Example 10 and Example 11), before and after thermoforming, respectively. The resistance before (FIG. 3c) and after (FIG. 3d) thermoforming are plotted as a function of % strain location and strain %, respectively. During thermoforming, the circuit lines/traces are formed into a shape of cone. As a result, the circuit line traces undergo stretching.

Compatibility and Thermoforming Attribute of Silver Inks with Various PC Substrates

Compatibility and thermoforming attribute of silver inks with various PC substrates were evaluated as per the ‘Cone Formability Test Procedure’ as described previously. In a typical process, silver ink was printed on different types of thermoformable PC substrate (DE as Makrafol DE1.4, V3 as MacDermid Autotype XFG250 M HCL V3, and 2L as MacDermid Autotype XFG250 2L substrates) as well as graphic Ink coated PC substrate (GCPC as MacDermid Autotype XFG2502L-HTR952). Since, graphic ink coated PC substrate (GCPC) was found mildly conducting, to avoid shorting, a layer of Dielectric Ink (Example 33) was printed before printing of Silver inks. Electrical resistances of the Silver conducting test circuits were measured before and after thermoforming process to record change of resistance at various % strain. After forming, change in electrical resistance along with other failure mechanisms is used to assess the degree of thermoformability. For example, FIG. 4a and FIG. 4b, show the variation of electrical resistance of conducting Silver circuit traces of 1000 μm line width of Silver Inks (Example 10) on various PC substrates, before and after thermoforming, respectively. The resistance before (FIG. 4a) and after (FIG. 4b) thermoforming are plotted as a function of % strain location and strain %, respectively. During thermoforming, the circuit lines/traces are formed into a shape of cone. As a result, the circuit line traces undergo stretching. FIG. 4c shows the microscopic images of the conducting Silver circuit traces of 1000 μm line width at 30, 37 and 46% strain of Silver Inks (Example 10) on various PC substrates, revealed very minimum distortion below 40% strain.

### Compatibility and Thermoforming Attribute of a Two-Stack, Dielectric and Silver Inks

Compatibility and thermoforming attribute of a two-stack, Dielectric and Silver Inks were evaluated as per the ‘Cone Formability Test Procedure’ as described previously. A typical two-stack circuit assembly was prepared by first printing of a Dielectric ink layer (Barrier Dielectric layer) on a thermoformable polymer substrate (eg. PC or PET) followed by printing of conducting silver circuit traces. The electrical resistances of the Silver conducting test circuits were measured before and after thermoforming process to record the change of resistance at various % strain. FIG. 5a and FIG. 5b show representative images of a typical test sample of before and after thermoforming, respectively. After forming, change in electrical resistance along with other failure mechanisms is used to assess the degree of thermoformability. For example, FIG. 5c and FIG. 5d, show the variation of electrical resistance of conducting Silver circuit traces of 1000 μm line width of Silver Ink (Example 1) printed on Dielectric Ink (Examples 33 & 35), Silver Ink Example 10 printed on Dielectric Ink (Example 33 & 35) and

Silver Ink (Example 11) printed on Dielectric Ink (Example 35), before and after thermoforming, respectively. The resistance before (FIG. 5c) and after (FIG. 5d) thermoforming are plotted as a function of % strain location and strain %, respectively. During thermoforming, the circuit lines/traces are formed into a shape of cone. As a result, the circuit line traces undergo stretching.

### Compatibility and Thermoforming Attribute of A Three-Stack Dielectric and Silver Inks

Compatibility and thermoforming attribute of a three-stack dielectric and silver inks were evaluated as per the ‘Cone Formability Test Procedure’ as described previously. A typical three-stack circuit assembly was prepared by first printing of a dielectric ink layer (barrier dielectric layer) on a thermoformable polymer substrate (eg. PC or PET), next printing of conducting silver circuit traces and followed by printing of another Dielectric ink layer (Protection layer). The electrical resistances of the conducting Silver test circuits were measured before and after thermoforming process to record the change of resistance at various % strain. FIG. 6a and FIG. 6b show representative images of a typical test sample of before and after thermoforming, respectively. After forming, change in electrical resistance along with other failure mechanisms is used to assess the degree of thermoformability. For example, FIG. 6c and FIG. 6d, show the variation of electrical resistance of conducting circuit traces of 1000 μm line width of Silver Ink (Example 10), where Barrier Dielectric layer and Protection layers were selected either as Example 35 or Example 47 or their combinations. The resistance before (FIG. 6c) and after (FIG. 6d) thermoforming are plotted as a function of %strain location and strain%, respectively. During thermoforming, the circuit lines/traces are formed into a shape of cone. As a result, the circuit line traces undergo stretching.

Thermoformable Conductive Compositions used as Conductive Adhesive to Attach Various SMD Components

Thermoformable conductive compositions disclosed in Example 1 to Example 26 can also be used as conductive adhesive to attach various SMD components, LED etc. to thermoformable conductive silver ink circuit traces. Viscosities of these formulations can be optimized to either dispose these conductive adhesives by dispensing or stencil printing. Compatibility of the thermoformable conductive adhesives with Silver Ink and substrates are very crucial to fabricate IME structures. FIG. 7 depicts a representative application of a thermoformable conductive adhesive composition (Example 7) for the attachment of SMD components on formable conducting Silver circuit traces (Example 10). For example, FIG. 7a shows the microscopic image of the dispensed dots of 650-700 μm diameter (wet deposit) of Example 7. FIGS. 7b and 7c shows the microscopic images of the wet assembly of SMD 1206 chip and SMD 1206 LED, respectively on formable conducting Silver circuit traces (Example 10). FIGS. 7d and 7e respectively shows thermally cured and dried formed of FIGS. 7b and FIG. 7c.

### Thermoforming Attribute of a Representative Conductive Circuit Structure

Thermoforming attribute of a representative conductive circuit structure, where components (such as, SMD 1206 Chip or SMD 1206 LED) are attached using conductive adhesive (Example 7) on Silver Ink (Example 10) on a thermoformable PC substrate (DE as Makrafol DE1.4), were evaluated as per the ‘Cone Formability Test Procedure’ as described previously. A typical assembly was prepared by first printing of a Silver ink (Example 10) conducting circuit traces on a thermoformable polymer substrate (DE), next dispensing of Example 7 and followed by component attachments of SMD 1206 Chip and SMD 1206 LED). Electrical continuity of these conducting circuit structure was checked by supplying electric current before and after thermoforming. For example, FIG. 8a and FIG. 8b show LEDs on printed conductive tracks before and after applying electrical current. In particular, lighted LEDs indicative of continuity of the circuit structures and corresponding stain locations are also indicated in FIGS. 8a and FIG. 8b. These results indicate the suitability of the use of Example 7 as conductive adhesive for the construction of thermoformable circuit assembly.

### Representative Stack of Screen-Printed Silver Layer/Thermoformable PC Substrate

FIG. 9 shows a representative stack of screen-printed silver layer//Thermoformable PC substrate (140), which produced structure 150 upon injection molding. Injection Molding was performed on the injection molding machine using center gate. The cavity dimension was 100mm×80mm. Injection molding was carried out in flat shape of thickness 2-3 mm and maximum weight of the part was around. Example 10 was used as silver ink and nascent PC substrate (Makrofol DE1.4) to prepare Structure 140, while this structure undergoes injection molding with PC resin to produce structure 150. Similarly, Example 1, Example 2, Example 4, Example 33, Example 34, Example 35 and Example 42 printed structures were also tested for injection molding performances with different combinations with various injection molded resins, such as PC, ABS etc. and are found to be stable during injection molding.

### Representative Functional 3D Electronic Device

FIG. 10 shows a design and construction of representative functional 3D electronic device. This device was produced by screen printing and drying of Example 1, followed attaching LED using Example 1 and then thermoforming the whole stack. FIG. 10 (a and b) are images of Handheld Type and (c and d) are Console types of Demonstrators capable of performing touch switching applications. The process involved first printing of Example 1 followed by drying. In second step involved stencil printing of Example 7 and LED placement followed by drying. LED was lightened by providing power though button cell.

### Representative Fully Functional IME Device

FIG. 11 shows a construction of representative fully functional IME device, which can be viewed as a protype of a typical Airplane Console panel. FIG. 11a and FIG. 11b are the optical images IME device in witched off and switch on condition, respectively. FIG. 11b, demonstrate the capacitive touch switching applications of such IME demonstrator. These device were produced by a multistep process, such as screen printing, thermal drying, dispensing, SMT component assembly, high-pressure thermoforming, laser cutting, injection molding (PC resin) and used various commercial graphic inks (such as, Proell) and Silver ink (Example 10), Dielectric Ink (Example 47), Conductive Adhesive (Example 7) and various MacDermid Autotype Xtraform PC substrates. These IME devices were constructed as a single film structure, where first several layers of decorative graphic inks (black and white) were printed and dried. This was followed by printing and drying of conducting electronic circuit layer using silver and dielectric inks and assembly of LEDs using conductive adhesive. This whole stack was further thermoformed, laser cut to trim as per the desired shape and back injection molded with PC resin. In FIG. 11b LEDs were lightened by providing power though button cell.

The foregoing detailed description has been provided by way of explanation and illustration, and is not intended to limit the scope of the appended claims. Many variations in the presently preferred embodiments illustrated herein will be apparent to one of ordinary skill in the art and remain within the scope of the appended claims and their equivalents.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. A composition for use in the manufacture of an in-mould electronic (IME) component, the composition containing a binder comprising:
a cross-linking agent comprising melamine formaldehyde,
a thermoplastic resin comprising a hydroxyl group, and
a solvent.

46. The composition of claim 45, wherein the melamine formaldehyde comprises hexamethoxymethyl melamine; and/or
wherein the cross-linking agent further comprises isocyanate and/or polyisocyanate and/or blocked polyisocyanate; and/or
wherein the thermoplastic resin comprises one or more of polyurethane resin, polyester resin, polyacrylate resin, polyvinyl ester resin, phenoxy resin and ketonic resin, preferably wherein the thermoplastic resin comprises polyurethane resin, polyester resin and phenoxy resin, more preferably wherein the thermoplastic resin comprises:
from 20 to 60 wt. % polyurethane resin, preferably from 35 to 47 wt. % polyurethane resin,
from 5 to 30 wt % polyester resin, preferably from 13 to 19 wt. % polyester resin, and
from 20 to 60 wt % phenoxy resin, preferably from 34 to 51 wt. % phenoxy resin, based on the total weight of the thermoplastic resin.

47. The composition of claim 45, wherein the thermoplastic resin:
comprises a homo-polymer, and co-polymer and/or a ter-polymer; and/or
has a glass transition temperature of less than 100° C.; and/or
has a weight average molecular weight of from 1000 to 100000 g/mol; and/or
has a softening point of less than 100° C.; and/or
has a hydroxyl content (OH number) of greater than 20 mgKOH/g; and/or
wherein the composition comprises:
from 1 to 40 wt % of the cross-linking agent, preferably from 7 to 24 wt. % of the cross-linking agent, and
from 60 to 99 wt % of the thermoplastic resin, preferably 76 to 93 wt. % of the thermoplastic resin,
based on the total amount of cross-linking agent and thermoplastic resin; and/or
wherein the solvent comprises one or more of a glycol ether acetate, a glycol ether, an ester,
a ketone, an alcohol and a hydrocarbon, preferably wherein the solvent comprises:
up to 95 wt % glycol ether acetate, preferably up to 85 wt. % glycol ether acetate, and/or
up to 95 wt % glycol ether, preferably up to 85 wt. % glycol ether, and/or
up to 15% ester, preferably up to 5 wt. % ester, and/or
up to 40 wt % ketone, preferably up to 32 wt. % ketone, and/or
up to 80 wt % alcohol, preferably up to 70 wt. % alcohol, and/or
up to 30 wt % hydrocarbon, preferably up to 22 wt. % hydrocarbon, based on the total weight of the solvent; and/or
wherein the binder further comprises:
a thermosetting resin, preferably comprising one or both of acrylic resin and epoxy resin; and
a curing catalyst for curing the thermosetting resin, preferably for thermally curing the thermosetting resin and/or for UV curing the thermosetting resin; and/or
wherein the binder further comprises one of more functional additives, preferably selected from one or more of surfactants, rheology modifiers, dispersants, de-foamers, de-tackifiers, slip additives, anti-sag agents, levelling agents, surface active agents, surface tension reducing agents, adhesion promoters, anti-skinning agents, matting agents, coloring agents, dyes, pigments and wetting agents; and/or
wherein the binder comprises:
from 0.5 to 12 wt. % of the cross-linking agent, preferably from 1.5 to 7.7 wt. % of the cross-linking agent;
from 10 to 40 wt. % of the thermoplastic resin, preferably from 11 to 30.4 wt. % of the thermoplastic resin; and
from 40 to 85 wt. % solvent, preferably from 46.7 to 78.8 wt. % solvent;
optionally:
from 0.1 to 30 wt. % thermosetting resin and from 0.1 to 3 wt. % curing catalyst for curing the thermosetting resin, preferably from 1 to 10 wt. % thermosetting resin and from 0.1 to 1 wt. % curing catalyst for curing the thermosetting resin; and/or
from 0.1 to 20 wt % functional additives, preferably from 1.7 to 17 wt. % functional additives.

48. The composition of claim 45, further comprising conductive particles, preferably wherein the conductive particles:
comprise one or more of metal particles, preferably selected from one or more of silver particles, copper particles, brass particles, nickel particles, gold particles, platinum particles, palladium particles, metal alloy particles, silver-coated copper particles, silver-coated brass particles, silver-nickel alloy particles and silver-copper alloy particles; and/or
comprise carbon particles, preferably selected from one or more of graphite particles, graphite flakes, carbon black particles, graphene flakes, graphene particles and carbon nanotubes; and/or
exhibit one or more of a mean particle size (d50) of from 1.25 to 7 μm, a tap density of from 2 to 4 g/cc, a surface area of from 0.3 to 2.1 m²/g, and an organic content of from 0.06 to 1.3 wt. %; and/or
are in the form of one or more of flakes, spheres, irregularly shaped particles, nano-powders and nanowire.

49. The composition of claim 48, comprising:
from 30 to 85 wt % binder, preferably from 40.1 to 80.9 wt. % binder, and
from 15 to 70 wt % conductive particles, preferably from 19.1 to 59.9 wt. % conductive particles; and/or
wherein the composition comprises:
from 30 to 85 wt % binder, preferably from 40.1 to 80.9 wt. % binder, and from 15 to 70 wt % conductive particles, preferably from 19.1 to 59.9 wt. % conductive particles,
and wherein the binder comprises:
from 0.2 to 6 wt. % cross-linking agent, preferably from 0.7 to 3.3 wt. % cross-linking agent,
from 1 to 7.5 wt. % polyurethane resin, preferably from 1.7 to 4.5 wt. % polyurethane resin,
from 0.1 to 5.5 wt. % polyester resin, preferably from 0.7 to 1.8 wt. % polyester resin,
from 1 to 7.5 wt. % phenoxy resin, preferably from 2.5 to 6.6 wt. % phenoxy resin,
from 0 to 10 wt. % thermosetting resin, preferably from 0 to 5.7 wt. % thermosetting resin,
from 0 to 1 wt. % curing catalyst, preferably from 0 to 0.6 wt. % curing catalyst,
from 0.2 to 10 wt % functional additives, preferably from 2.6 to 7.4 wt. % functional additives,
from 0 to 60 wt % glycol ether acetate, preferably from 4.3 to 43.2 wt. % glycol ether acetate,
from 0 to 40 wt % glycol ether, preferably from 0 to 24.1 wt. % glycol ether,
from 0 to 5 wt. % ester, preferably from 0 to 1.7 wt. % ester, and
from 0 to 30 wt % ketone, preferably from 0 to 20.5 wt. % ketone.

50. The composition of claim 48 in the form of a conductive ink.

51. The composition of claim 48 in the form of a conductive adhesive.

52. The composition of any of claims 45, further comprising non-conductive particles, preferably wherein the non-conductive particles:
comprise organic non-conductive particles, preferably selected from one or more of cellulose, wax, polymer microparticles, non-conductive carbon particles and graphene oxide; and/or
comprise inorganic non-conductive particles, preferably selected from one or more of mica, silica (SiO₂), fumed silica, talc, titanium dioxide (TiO₂), alumina, barium titanate (BaTiO₃), zinc oxide (ZnO) and boron nitride (BN), optionally wherein the inorganic non-conductive particles are sub-micron and micron sized; and/or
exhibit a mean particle size (d50) of less than or equal to 10 μm.

53. The composition of claim 52, comprising:
from 0 to 50 wt. % non-conductive particles, preferably from 2 to 45 wt. % non-conductive particles, and
from 50 to 100 wt. % binder, preferably from 55 to 98 wt. % binder; and/or
wherein the composition comprises:
from 40 to 100 wt. % binder, preferably 50 to 98 wt. % binder, and
from 0 to 60 wt. % non-conductive particles, preferably from 2 to 50 wt. % non-conductive particles,
and wherein the binder comprises:
from 0.5 to 10 wt % cross-linking agent, preferably from 1.9 to 6.1 wt. % cross-linking agent,
from 2 to 12 wt % polyurethane resin, preferably from 4.8 to 8.4 wt. % polyurethane resin,
from 0.5 to 10 wt. % polyester resin, preferably from 1.9 to 5.3 wt. % polyester resin,
from 2 to 18 wt % phenoxy resin, preferably from 4.5 to 12.4 wt. % phenoxy resin,
from 0 to 30 wt. % thermosetting resin, preferably from 0 to 19.6 wt. % thermosetting resin,
from 0 to 3 wt. % curing catalyst, preferably from 0 to 2 wt. % curing catalyst,
from 0.3 to 17 wt. % functional additives, preferably from 1.4 to 12.5 wt. % functional additives,
from 0 to 41.7 wt. % glycol ether acetate, preferably from 4.9 to 41.7 wt. % glycol,
from 0 to 60 wt. % glycol ether, preferably from 0 to 43.8 wt. % glycol ether,
from 0 to 30 wt. % ketone, preferably from 0 to 19.9 wt. % ketone,
from 0 to 50 wt. % alcohol, preferably from 0 to 35.5 wt. % alcohol, and
from 0 to 20 wt. % hydrocarbon, preferably from 0 to 13.3 wt. % hydrocarbon.

54. The composition of claim 45 in the form of a dielectric ink.

55. The composition of claim 45 in the form of a non-conductive adhesive.

56. The composition of claim 45 in the form of an encapsulant.

57. The composition of claim 45 further comprising a colorant and/or dye and/or pigment, the composition in the form of a graphic ink.

58. A method of manufacturing the composition of claim 45, the method comprising:
providing a solvent,
providing a thermoplastic resin having a hydroxyl group,
dissolving the thermoplastic resin in the solvent at a temperature of from 50 to 100° C., preferably from 70 to 100° C.,
cooling the solution to room temperature,
optionally adding to the cooled solution one or more of functional additives, thermosetting resins, curing catalysts for curing the thermosetting resins, conductive particles and non-contacting particles.

59. A method of manufacturing an in-mould electronic (IME) component, the method comprising:
preparing a blank; and
thermoforming the blank,
wherein preparing the blank comprises forming one or more structures on a thermoformable substrate, each structure formed by a method comprising:
disposing the composition of claim 45 on a thermoformable substrate, and drying the composition at a temperature of from 20 to 150° C. for from 0.5 to 60 minutes.

60. The method of claim 59, wherein the one or more structures are selected from a conductive layer, a conducting track layer, an adhesive attachment layer, a dielectric layer, an encapsulant layer, a graphic layer and a barrier layer; and/or
wherein the one or more structures comprises a multilayer stack; and/or
wherein the one or more structures comprises a printed circuit board; and/or
wherein disposing the composition comprises printing the composition, preferably screen-printing the composition; and/or
wherein the substrate comprises polycarbonate (PC) and/or polyethylene terephthalate (PET); and/or
wherein the thermoforming is carried out at a temperature of from 140° C. to 210° C. and/or at a pressure of from 0.25 MPa to 0.4 MPa and/or at a pressure ranging from 6 MPa to 12 MPa; and/or
further comprising attaching one or more electronic devices to the blank using a conductive adhesive or a non-conductive adhesive, wherein the attaching takes place before and/or after thermoforming; and/or
further comprising, after thermoforming, applying a layer of resin to the substrate using injection moulding, preferably wherein the resin comprises one or more of polycarbonate (PC), polyethylene terephthalate (PET), acrylonitrile butadiene styrene (ABS), polypropylene (PP), polyester, poly(methyl methacrylate) (PMMA), low density polyethylene (LDPE), high-density polyethylene (HDPE), polystyrene (PS) and thermoplastic polyurethane (TPU); and/or
wherein the injection moulding is carried out at a temperature of from 170 to 330° C.; and/or
wherein the in-mould electronic (IME) component comprises a capacitive touch switch, a resistive touch switch or a capacitive touch sensor, or wherein the in-mould electronic (IME) component comprises one or more of a display, a light/lamp, a sensor, an indicator and a haptic/touch feedback device.

61. An in-mould electronic (IME) component manufactured according to the method of claim 59.

62. An in-mould electronic (IME) component comprising the composition of claim 45.

63. The in-mould electronic (IME) component of claim 61 comprising a capacitive touch switch or a resistive touch switch.

64. The in-mould electronic (IME) component of claim 61 comprising one or more of a display, a light/lamp, a sensor, an indicator and a hepatic/touch feedback device.
